(19) United States
(12) Patent Application Publication
(10) Pub. No.: US 2005/0276155 A1
(43) Pub. Date: Dec. 15, 2005

(54) Volumetric solid and liquid dispenser

(76) Inventor: Archie J. Harris, Gastonia, NC (US)

Correspondence Address: Adams Evans P.A.;2180 Two Wachovia Center, 301 S. Tryon Street, Charlotte, NC, 28282, US

(21) Appl. No.: 11/139,218

(22) Filed: May 27, 2005

Related U.S. Application Data
(63) Continuation-in-part of application No. 10/305,506, filed on Nov. 27, 2002, now Pat. No. 6,905,048.

(51) Int. Cl. B28C 7/04

(52) U.S. Cl. 366/19; 366/40; 366/142

(57) ABSTRACT

A volumetric solid and liquid dispenser includes a drum sized for receiving and containing a predetermined volume of solid material from a solid material supply source. The supply source can be a hopper positioned above the drum. The drum is rotatably mounted to a support frame and can be rotated from a position in which it receives solid material from the supply source to a dispensing position in which it dispenses the solid material into a receptacle below. A liquid metering and dispensing assembly dispenses a predetermined volume of liquid into the receptacle for mixing with the solid material. The invention is particularly useful for dispensing predetermined volumes of sand and water into a cement mixer for mixing with mortar. The invention can include a lifter assembly for lifting material to be poured into the mixer, and a cover assembly for covering the top of the hopper.

This application is a continuation-in-part of U.S. application Ser. No. 10/305,506, filed Nov. 27, 2002.

### TECHNICAL FIELD AND BACKGROUND OF THE INVENTION

The invention relates to an apparatus for metering and dispensing solid and liquid materials. The invention is particularly useful for metering and dispensing certain volumes of sand and water into a cement mixer for mixing with mortar to form cement.

The task of mixing sand, water and mortar mix to form cement is a common activity on construction sites. In order to produce cement of acceptable hardness and quality, the sand, water and mortar must be mixed in specific ratios. The amount of sand and water added to the mixture has a direct impact on the color and hardness of the cement. For example, the amount of sand particularly impacts two important qualities of the cement-color and hardness. Color is particularly important when the cement is being used as a grout, and hardness is critical to virtually every application of cement. As such, masons must take time to accurately measure specific volumes of sand and water to mix with a certain weight of mortar to produce a cement having satisfactory hardness and other desired qualities. A mistake in measuring the sand and water can lead to cement of unacceptable quality causing substantial losses in time and money. In addition, government regulations in recent years have increasingly required cement used in various construction projects to have a certain hardness, making accurate measurement of ingredients all the more critical.

Industry-wide construction standards generally require the cement to have a hardness of 1800 pounds per square inch (p.s.i.). Mortar mix is typically packaged and sold in bags containing seventy-two pounds of mortar. In addition, most commercial cement mixers are designed to receive and mix two seventy-two pound bags of mortar mix. According to industry standards, six cubic feet of sand and approximately ten gallons of water are required to be mixed with 144 pounds of mortar mix to produce cement having a hardness of 1800 p.s.i. As such, it is common for masons to have to measure six cubic feet of sand and ten gallons of water to mix with 144 pounds of mortar mix. Generally, workers measure the sand and water by hand using conventional measuring devices, and then pour the sand and water by hand into the cement mixer along with two bags of mortar. This is a time-consuming and inefficient process that is prone to human error, particularly in the hectic environment of the typical construction site. In addition, the quality of the product can vary depending on the training and skills of the workers measuring and mixing the ingredients. Furthermore, there is a risk of injury to the workers due to the fact that workers must position themselves close to the mixer, which has dangerous blades, in order to pour the sand, water and mortar into the mixer.

In an effort to overcome and eliminate the aforementioned problems, the present invention was conceived.

### SUMMARY OF THE INVENTION

Therefore it is an object of the present invention to provide an apparatus capable of efficiently and accurately metering a desired volume of solid and liquid materials.

It is another object of the invention to provide an apparatus for dispensing a certain volume of sand and water into a mixer for mixing with mortar to make cement.

It is yet another object of the invention to provide an apparatus that minimizes the risk of injury to personnel involved in making cement by reducing the number of approaches to the mixer necessary to produce a predetermined amount of cement.

These and other objectives of the present invention are achieved by providing a an apparatus for dispensing a solid material and a liquid material into a receptacle having a drum with an opening sized for receiving and containing a predetermined volume of solid material, and a hopper positioned above the drum for allowing the free flow of the solid material into the drum. The apparatus includes a discharge assembly for discharging the predetermined volume of solid material from the drum into the receptacle, a liquid dispensing assembly for dispensing a predetermined volume of liquid material into the receptacle for mixing with the solid material, and a support frame for mounting the drum, hopper and liquid dispensing assembly in an elevated position above the mixer.

According to a preferred embodiment of the invention, the receptacle is a cement mixer.

According to another preferred embodiment of the invention, the apparatus includes a lifter assembly for lifting material to be placed into the mixer. The lifter assembly is moveable from a loading position for loading the material on the lifter assembly to an unloading position proximate to the mixer for placing the material into the mixer.

According to yet another preferred embodiment of the invention, the lifterassembly is pivotally connected to the support frame.

According to yet another preferred embodiment of the invention, the lifter assembly includes a platform for carrying the material to be placed in the mixer.

According to yet another preferred embodiment of the invention, the lifter assembly includes means for elevating the platform, so that the platform is elevated from the loading position in which the platform is proximate a ground surface, and the unloading position in which the platform is proximate an upper opening of the mixer.

According to yet another preferred embodiment of the invention, the lifter assembly includes a hydraulic lift for elevating the platform, so that the platform is moveable from the loading position in which the platform is proximate a ground surface, and the unloading position wherein the platform is proximate an upper opening of the mixer.

According to yet another preferred embodiment of the invention, the lifter assembly includes an arm having a first end carried by the hydraulic lift and a second end for carrying the platform.

According to yet another preferred embodiment of the invention, the discharge assembly comprises a drive apparatus for moving the drum from a receiving position in which the opening in the drum is positioned to receive the solid material, and a dispensing position in which the opening in the drum is inverted to dispense the solid material to the mixer positioned below the drum.

According to yet another preferred embodiment of the invention, a splash guard is positioned below the drum and defines a pathway for solid material flowing from the drum to the mixer. The splash guard is connected to at least one adjustable member mounted on the support frame so that the position of the splash guard can be adjusted in relation to the height of the mixer.

According to yet another preferred embodiment of the invention, the drum includes a cylindrical side wall and two opposed lateral end walls, and the drum opening is formed in the cylindrical side wall. A containment shield is positioned adjacent to the cylindrical side wall of the drum and adapted to conform to the cylindrical sidewall and cover the drum opening as the drum is rotated between the receiving and dispensing positions so that the containment shield prevents escape of the solid material through the drum opening while positioned between the receiving and dispensing positions.

According to yet another preferred embodiment of the invention, the hopper includes a top opening for receiving the solid material and a base opening for dispensing the solid material, and a cover assembly is provided for covering the top opening of the hopper.

According to yet another preferred embodiment of the invention, the cover assembly includes an arm mounted on the support frame, and a cover having a first end carried by the arm and a second end wound on a roller mounted on the support frame. The arm is biased away from the roller to maintain tension in the cover so that rotation of the roller alters an extent of coverage of the top opening of the hopper by the cover.

According to yet another preferred embodiment of the invention, the cover can be opened and closed by selectively rotating the roller in clockwise and counterclockwise directions.

According to yet another preferred embodiment of the invention, the cover assembly includes a chain engaging the roller and a crank mounted on the support frame, so that the roller can be rotated by turning the crank.

According to yet another preferred embodiment of the invention, a guard panel is mounted on the support frame and positioned above the hopper to protect the hopper during loading of the solid material into the hopper.

According to yet another preferred embodiment of the invention, at least one fork lift channel is mounted on the support frame for receiving a fork from a fork lift so that the dispensing apparatus can be moved by a fork lift.

According to yet another preferred embodiment of the invention, the fork lift channel has at least one aperture, and a lock pin is provided for inserting in the aperture to maintain the fork within the fork channel.

According to yet another preferred embodiment of the invention, the liquid dispensing assembly includes a container mounted on the support frame and having an entry opening in communication with a source for the liquid material and an exit opening for exiting the predetermined volume of liquid material. The float assembly positioned within the container and including a float suspendable on the liquid material and operatively associated with a first valve proximate the entry opening so that raising the float to a predetermined level within the container closes the first valve over the entry opening to prevent entry of additional liquid material into the container. A moveable support member is positioned within the container and carries the float assembly. A cable is in communication with the support member and operatively associated with an adjustment piece positioned outside of the container so that the height of the float assembly can be adjusted by moving the adjustment piece.

According to yet another preferred embodiment of the invention, the adjustment piece includes a gear box.

According to yet another preferred embodiment of the invention, the liquid dispensing assembly includes a second valve proximate the exit opening, a lever operatively associated with the second valve so that the lever is moveable from a dispensing position in which the second valve is open to a filling position in which the second valve is closed.

According to yet another preferred embodiment of the invention, the lever is operatively associated with the first valve so that the lever is moveable from the dispensing position in which the first valve is closed and the second valve is open to the filling position in which the first valve is open and the second valve is closed.

According to yet another preferred embodiment of the invention, the apparatus includes an indicator having markings showing at least two predetermined volumes that can be dispensed by the liquid dispensing assembly. The cable includes a first end positioned within the indicator and a second end connected to the support frame. The position of the first end of the cable relative to the markings of the indicator corresponds to the volume of the liquid material to be dispensed from the liquid dispensing assembly so that a desired volume of liquid material can be obtained by moving the cable with the adjustment piece so that the first end of the cable is positioned at the marking corresponding to the desired volume.

According to yet another preferred embodiment of the invention, the support member includes at least two telescoped rods, and the cable is positioned within a tube extending from the indicator to the support frame.

According to yet another preferred embodiment of the invention, a portion of the tube proximate the markings on the indicator is clear so that the cable is visible to a user. between the blocks and the elongate member prevents rotation of the drum beyond approximately one hundred eighty degrees.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a front elevation of a preferred embodiment of the volumetric solid and liquid dispenser according to the invention, shown with a cement mixer;

FIG. 2 is a rear elevation of the preferred embodiment shown in FIG. 1;

FIG. 3 is a side elevation of the preferred embodiment shown in FIG. 2;

FIG. 4 is another side elevation of the preferred embodiment shown in FIG. 3;

FIG. 5 is a perspective view of the drum of the volumetric solid and liquid dispenser according to a preferred embodiment of the invention;

FIG. 6 is another perspective view of the drum of FIG. 5, showing the containment shield pivoted upward;

FIG. 7 is a top plan view of the hopper of the volumetric solid and liquid dispenser shown in FIG. 1;

FIG. 8 is a partial cross-sectional view of the volumetric solid and liquid dispenser shown in FIG. 1;

FIG. 9 is a partial enlarged view of the volumetric solid and liquid dispenser shown in FIG. 1;

FIG. 10 is another partial enlarged view of the volumetric solid and liquid dispenser shown in FIG. 1;

FIG. 11A is a schematic view of the volumetric solid and liquid dispenser of FIG. 1, showing the drum rotating towards the receiving position;

FIG. 11B is a schematic view of the volumetric solid and liquid dispenser of FIG. 1, showing the drum in position to receive sand from the hopper;

FIG. 11C is a schematic view of the volumetric solid and liquid dispenser of FIG. 1, showing the drum rotating from the receiving position toward the dispensing position;

FIG. 11D is a schematic view of the volumetric solid and liquid dispenser of FIG. 1, showing the drum in position to dispense sand into the cement mixer;

FIG. 12 is a partial enlarged view of the volumetric solid and liquid dispenser of FIG. 1;

FIG. 13 is another partial enlarged view of the volumetric solid and liquid dispenser of FIG. 1;

FIG. 14 is a cross sectional view of the liquid metering and dispensing container of the volumetric solid and liquid according to a preferred embodiment of the invention;

FIG. 15 is a front elevation of another preferred embodiment of the volumetric solid and liquid dispenser according to the invention;

FIG. 16 is a rear elevation of the preferred embodiment shown in FIG. 15;

FIG. 17 is a side elevation of the preferred embodiment shown in FIG. 15;

FIG. 18 is another side elevation of the preferred embodiment shown in FIG. 15;

FIG. 19 is a partial front elevation of the preferred embodiment shown in FIG. 15;

FIG. 20 is a partial perspective view of the preferred embodiment shown in FIG. 15;

FIG. 21 is another partial perspective view of the preferred embodiment shown in FIG. 15;

FIG. 22 is yet another partial perspective view of the preferred embodiment shown in FIG. 15;

Figure is another side elevation of the preferred embodiment shown in FIG. 15;

FIG. 24 is yet another side elevation of the preferred embodiment shown in FIG. 15;

FIG. 25 is an environmental view showing the preferred embodiment of FIG. 15 being transported on a truck bed.

FIG. 26 is yet another partial perspective view of the preferred embodiment shown in FIG. 15;

FIG. 27 is a partial cross sectional view of the preferred embodiment shown in FIG. 15;

FIG. 28 is yet another front elevation of the preferred embodiment shown in FIG. 15;

FIG. 29 is yet another rear elevation of the preferred embodiment shown in FIG. 15;

FIG. 30 is yet another side elevation of the preferred embodiment shown in FIG. 15;

FIG. 31 is a perspective view of the preferred embodiment shown in FIG. 15;

FIG. 32 is yet another perspective view of the preferred embodiment shown in FIG. 15;

FIG. 33 is yet another perspective view of the preferred embodiment shown in FIG. 15;

FIG. 34 is yet another perspective view of the preferred embodiment shown in FIG. 15; and

FIG. 35 is yet another partial perspective view of the preferred embodiment shown in FIG. 15.

### DETAILED DESCRIPTION OF THE PREFERRED EMBODIMENTS AND BEST MODE

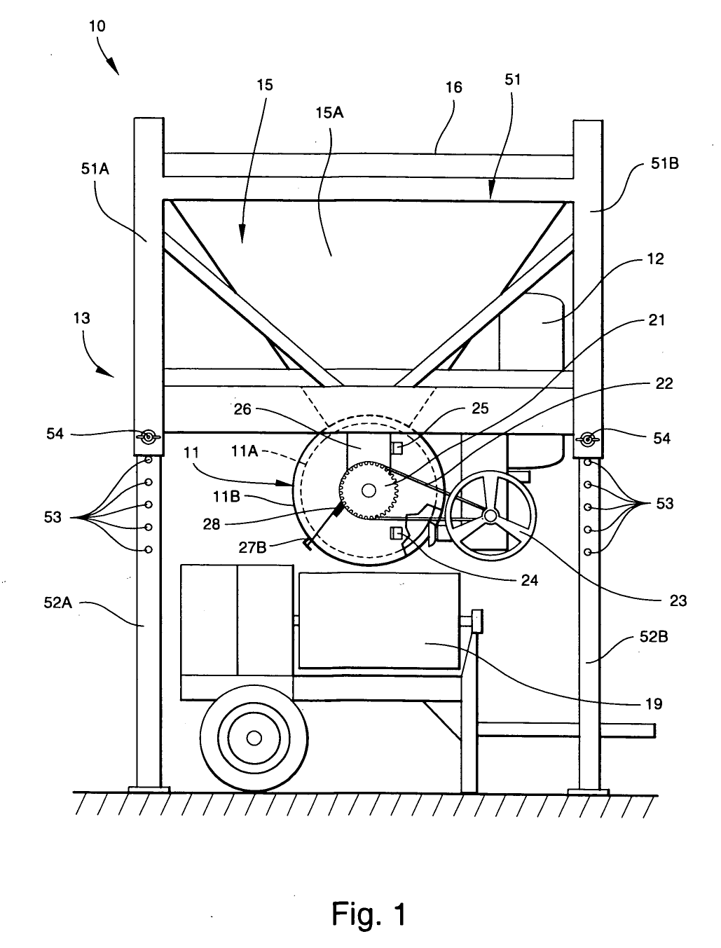

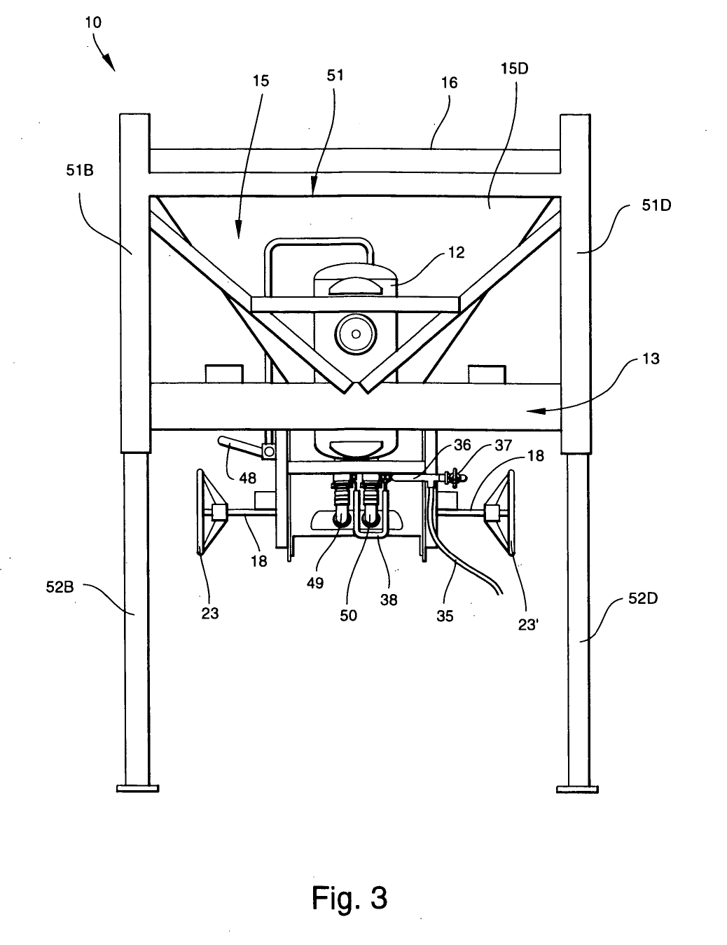

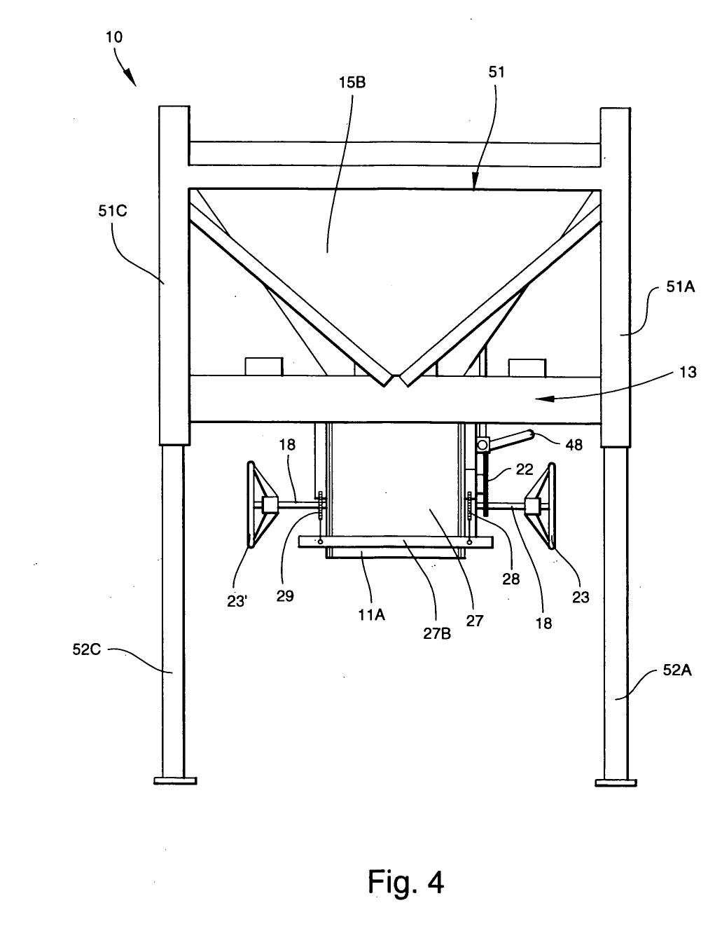

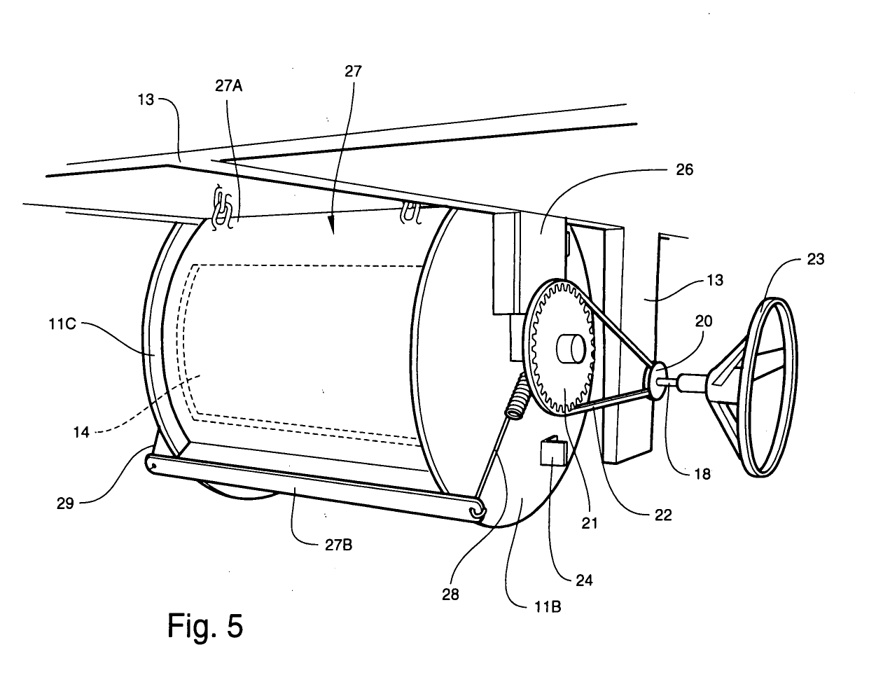

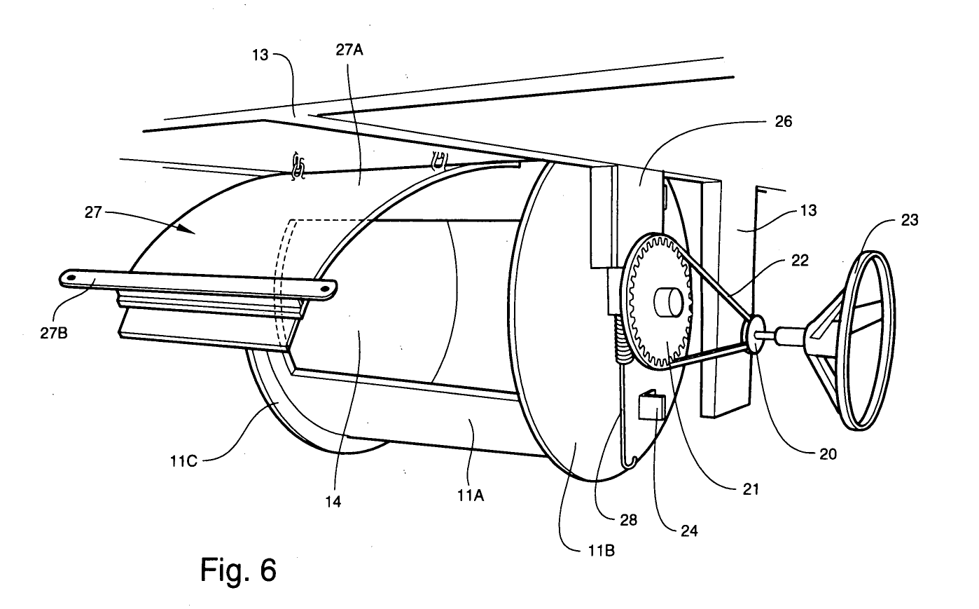

Referring now specifically to the drawings, a preferred embodiment of the volumetric solid and liquid dispenser according to the present invention is illustrated in FIGS. 1-4, and shown generally at reference numeral 10. The dispenser 10 comprises a drum 11 and a liquid metering and dispensing container 12 mounted on a support frame 13. The drum 11 holds a predetermined volume of solid material and has an opening 14 through which the solid material enters and exits the drum 11, as shown in FIGS. 5 and 6. The container 12 stores and delivers a predetermined volume of a liquid.

The dispenser 10 can be used to deliver measured volumes of any variety of solids and liquids. For example, the dispenser 10 can be used for dispensing sand and water in an appropriate volumetric ratio for mixing with mortar to make cement.

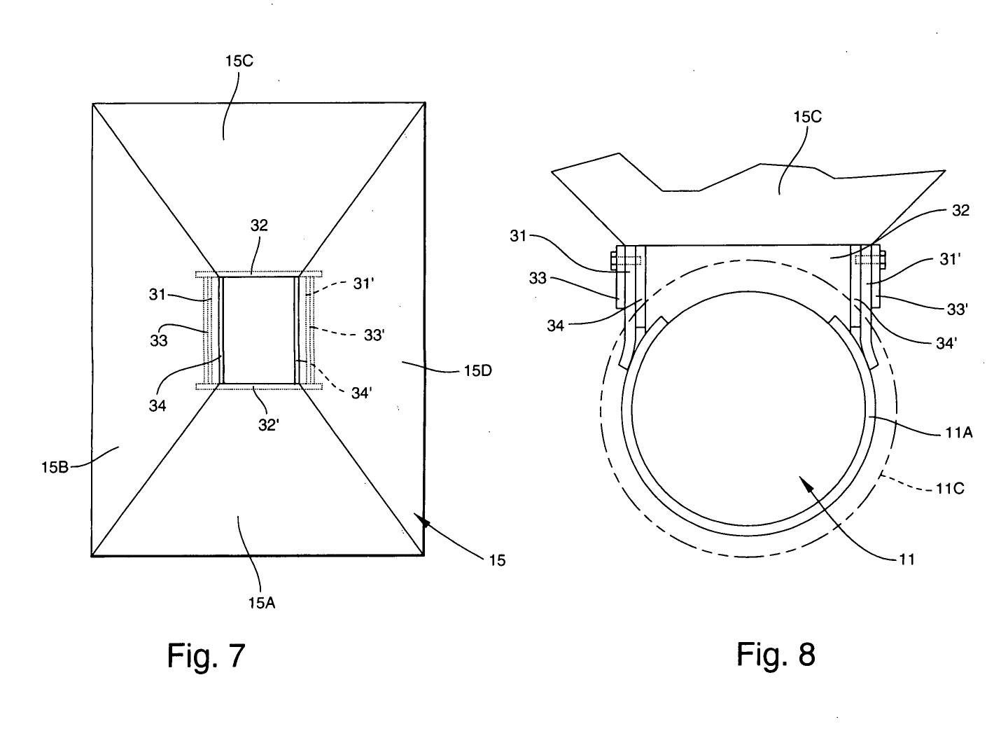

As can be seen in FIGS. 1-4, the dispenser 10 includes a hopper 15 mounted on the support frame 13 above the drum 11. The hopper 15 preferably comprises four walls 15A-D defining a relatively large top opening 16 and converging into a relatively small base opening 17, as shown in FIG. 7. The base opening 17 is positioned directly above the drum 11. The hopper 15 preferably holds approximately 108 cubic feet of sand, which can supply the typical crew of eight masons for one full day of work. The sand can be poured into the hopper 15 by a forklift or other suitable equipment.

As shown in FIGS. 5 and 6, the drum 11 preferably comprises a cylindrical sidewall 11 A and two opposed lateral end walls 11B, 11C. The drum 11 can be of any volume but is preferably sized to hold six cubic feet of sand.

The drum opening 14 is formed within the cylindrical side wall 11A as shown in FIGS. 5 and 6, and is shaped similarly to and sized slightly smaller than the base opening 17 of the hopper 15, as shown in FIG. 8. The drum 11 is rotatably mounted to the support frame 13 such that the drum 11 can be rotated relative to the hopper 15 thereby moving the drum opening 14 in and out of alignment with the hopper base opening 17.

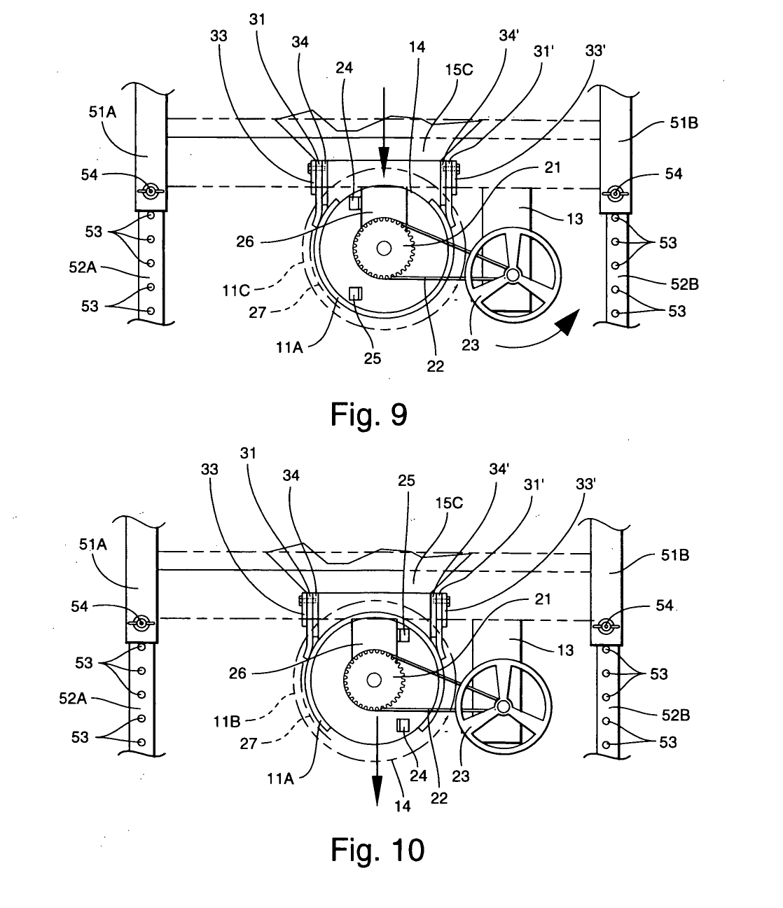

A drive apparatus communicates with the drum 11 to rotate the drum between a receiving position, shown in FIG. 9, in which the drum opening 14 is upwardly directed and aligned with the hopper base opening 17, and a dispensing position, shown in FIG. 10, in which the drum opening 14 is downwardly directed and aligned with a receptacle 19, shown in FIG. 1. The receptacle 19 is preferably a standard commercial cement mixer.

As shown in FIG. 5, the drive apparatus comprises a drive sprocket 20 rotatably mounted on the support frame 13 and a relatively larger sprocket 21 mounted on one lateral end wall 11B of the drum 11. The sprockets 20, 21 are connected by a chain 22 engaging the teeth of the sprockets 20, 21 such that rotation of the drive sprocket 20 rotates sprocket 21 thereby rotating the drum 11. An enlarged wheel 23 is mounted on the drive sprocket 20 to assist the user in manually rotating the drive sprocket 20. The wheel 23 is preferably twenty inches in diameter and made of stainless steel. Alternatively, an electric motor can be used to rotate the drive sprocket 20.

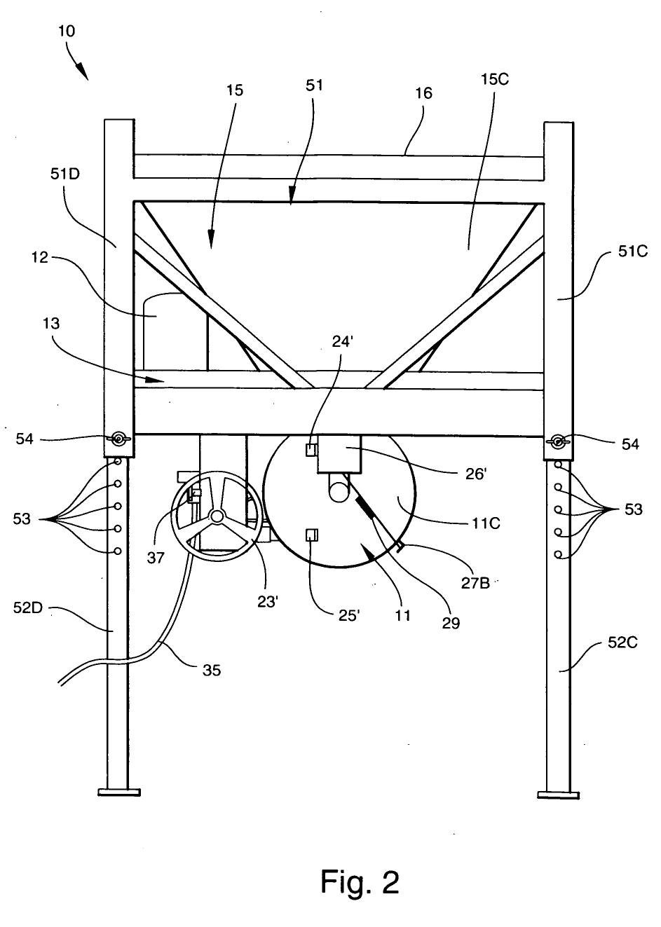

As shown in FIG. 2, the dispenser 10 includes a second enlarged wheel 23′ positioned on the opposite side of the support frame 13. The second wheel 23′ is connected to the first wheel 23 by an axle 18, enabling the user to operate the dispenser 10 from the front or rear to avoid the wind.

As shown in FIG. 1, two stop blocks 24, 25 are affixed one hundred eighty degrees apart from each other on the lateral end wall 11B. Contact between the stop blocks 24, 25 and an elongate member 26 on the support frame 13 positioned adjacent lateral end wall 11B prevent the drum 11 from rotating more than one hundred eighty degrees. Similarly, stop blocks 24′, 25′ are positioned on the other lateral end wall 11B, and contact elongate member 26′.

When the drum 11 is positioned in the receiving position, shown in FIG. 9, the drum opening 14 is aligned with the hopper base opening 17 to allow sand contained in the hopper 15 to flow by gravity into the drum 11. Sand flows freely into the drum 11 until it is full with six cubic feet of sand in the drum 11. As shown in FIGS. 9-10, the drum is moved from the receiving position to the dispensing position by rotating the wheel 23 counterclockwise until stop block 25 contacts the elongate member 26, preventing further rotation of the drum 11. As shown in FIG. 10, the drum opening 14 is downwardly directed to allow sand to flow out of the drum 11 by means of gravity and into the cement mixer 19, thereby providing six cubic feet of sand for mixing in mixer 19. The drum can be repositioned in the receiving position by rotating the wheel 23 clockwise until stop block 24 contacts elongate member 26, as shown in FIG. 9. If the user attempts to rotate the drum 11 from the receiving position to the dispensing position when the drum 11 is only partially full of sand, the resulting unbalanced load will cause the drum 11 to move in the opposite direction back toward the receiving position. As such, the user is alerted when the drum 11 is not filled with the desired volume of sand and can reposition the drum 11 to receive additional sand until completely filled.

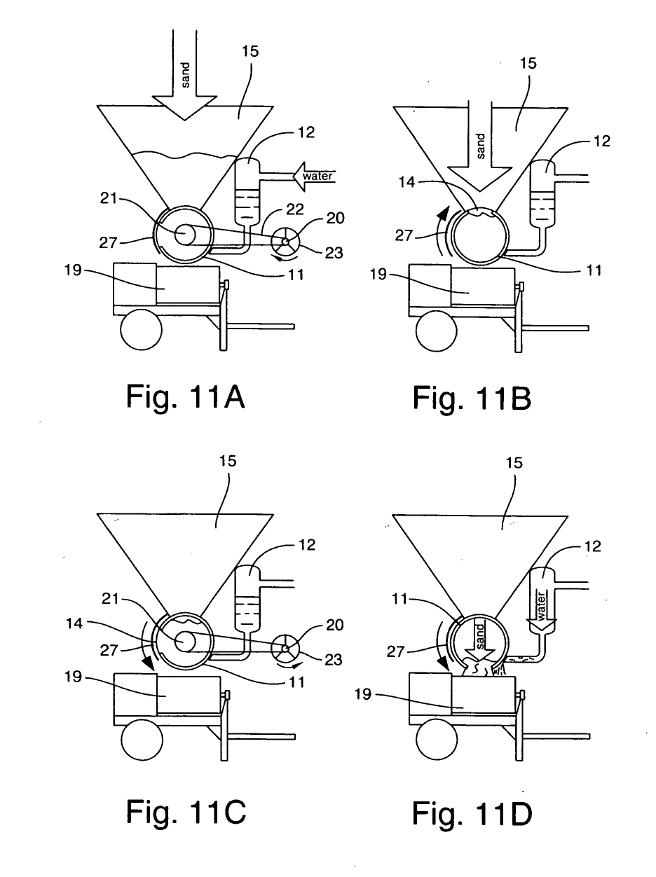

As shown in FIG. 5 and 6, a containment shield 27 is positioned adjacent the drum to prevent escape of sand from the drum 11 due to centrifugal forces while it is being rotated from the receiving position to the dispensing position, as demonstrated in FIGS. 11B-11D. As can best be seen in FIGS. 5 and 6, the containment shield 27 is an arcuate plate sized to conform to the curvature of the cylindrical sidewall 11A. The top end 27A of the containment shield 27 is pivotally mounted to the support frame 13 proximate the hopper 15. The containment shield 27 extends approximately one-hundred to one hundred eighty degrees around the drum 11, and has a terminal end 27B releasably connected to spring loaded latches 28, 29. The spring loaded latches 28, 29 are attached, respectively, to the lateral end walls 11B, 11C of the drum 11. It is common for pebbles, stones and other relatively large errant matter to be present in sand packaged and sold for use in cement. The spring loaded latches 28, 29 securely maintain the containment shield 27 adjacent the cylindrical wall 11A, while providing a resiliency to prevent the permanent lodging of stones, pebbles or other errant material between the containment shield 27 and the drum 11. In the event a stone or pebble flows into the crevice between the drum 11 and containment shield 27 while the drum 11 is being rotated from the receiving position to the dispensing position, the spring loaded latches 28, 29 and the pivotal mounting of the containment shield 26 provide a resilience in the containment shield 27 that allows stones and pebbles between the drum 11 and the containment shield 27 to fall out as the drum 11 rotates. As such, errant stones and pebbles do not remain lodged between the drum 11 and containment shield 27, and rotation of the drum 11 continues uninhibited. As shown in FIG. 6, an elastic mat 30, preferably made of rubber, can be affixed to the underside of the containment shield 27 proximate the terminal end 27B to facilitate smooth rotation of the drum 11 by reducing frictional forces generated by contact between the drum 11 and the containment shield 27.

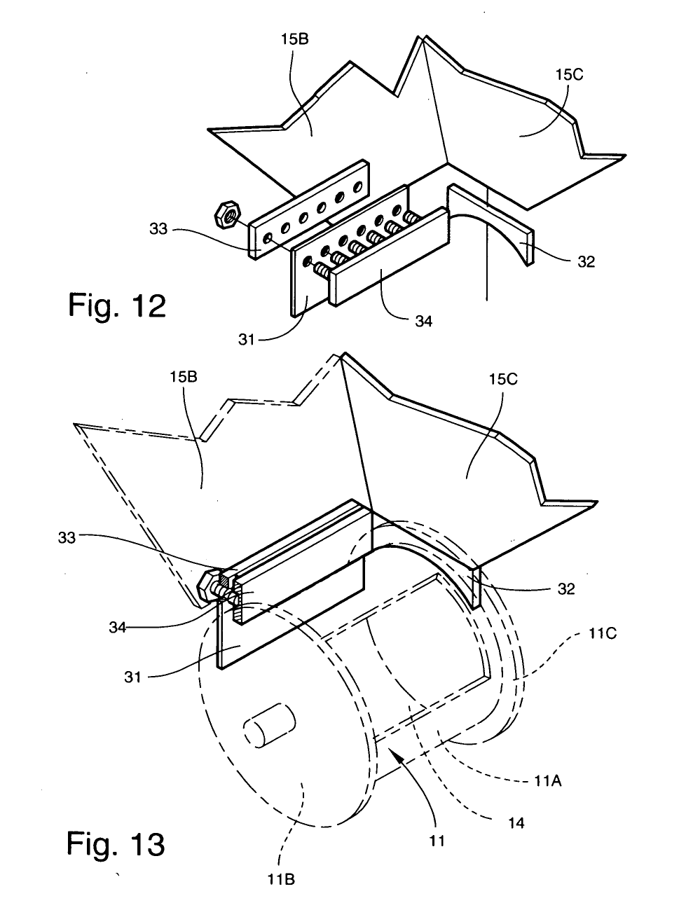

As shown in FIGS. 7 and 8, two elastic segments 31, 31′, preferably made of rubber, can be affixed to the opposite sides 15B, 15D, respectively, of the hopper proximate the base opening 17 such that the segments 31, 31′ extend transversely to the direction of rotation of the drum 11. Two curved segments 32, 32′ are affixed to opposite sides 15A, 15C of the hopper 15 proximate the base opening 17 such that the curved segments 32, 32′ extend lengthwise in the same direction as the rotation of the drum 11. As shown in FIG. 7, the curved segments 32, 32′ are curved at an angle corresponding to the curvature of the drum 11 so that the curved segments 32, 32′ and drum 11 compliment each other. As shown in FIG. 7, the elastic segments 31, 31′ and curved segments 32, 32′ communicate to define a confined pathway for the sand in the hopper 15 to flow through and into the drum 11. In addition, the elasticity of the segments 31, 31′ facilitate smooth rotation of the drum by reducing friction. As shown in FIGS. 7, 8, 12 and 13, the elastic segment 31 is sandwiched between two connecting panels 33, 34 attached to hopper wall 15B. Elastic segment 31′ is similarly positioned between connecting panels 33′, 34′ attached to hopper wall 15D.

The liquid metering and dispensing container 12 receives and dispenses a desired volume of liquid into the cement mixer 19. The container 12 preferably holds approximately fifteen gallons of liquid water. Preferably, the container 12 receives and dispenses approximately ten gallons of water into the cement mixer 19 for mixing with six cubic feet of sand and 144 pounds of mortar mix.

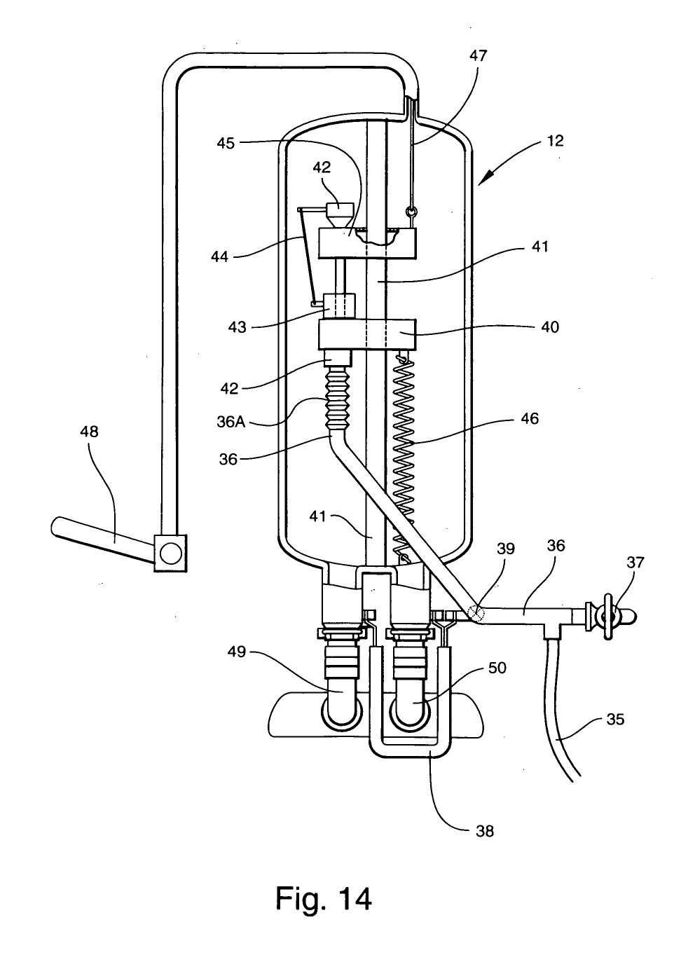

As shown in FIG. 14, a supply hose 35 is connected to a water supply source (not shown) and supplies water to a receiving pipe 36. One end of the receiving pipe 36 leads to the container 12, while the opposite end leads to a faucet 37 that provides an auxiliary water supply for cleaning or other work site duties. A control lever 38 communicates with a control valve 39 that is positioned within the receiving pipe 36 prior to entering the container 12 to control the flow of water into the container 12. When the control lever 38 is positioned downward, the control valve 39 is closed and no water can enter the container 12. Moving the control lever 38 upward opens the control valve 39 to allow water to continue to flow through the receiving pipe 36 and ultimately enter the container 12.

As can best be seen in FIG. 14, a filling mechanism is positioned inside of the container 12 that operates similarly to a toilet. The receiving pipe 36 enters the container 12 and terminates at a lower support member 40 positioned midway in the container 12 on a center support rod 41. A filler valve 42 is affixed to the terminal end of the receiving pipe 36. A filler float 43 communicates with the filler valve 42 via a connecting wire 44 to cut off the flow of water into the container 12 once a certain volume of water has been attained. As water fills up the container 12, the float 43 rises with the water. When the float 43 reaches the upper support member 45, the filler valve 42 closes to stop further flow of water into the container 12. As such, the volume of water entering the container can be controlled by positioning of the support members 40, 45 at a certain height on the support rod 41. The lower support member 40 is connected to the base of the container 12 by a spring loaded coil 46 to allow vertical movement of the support members 40, 45 along the support rod 41. In addition, the receiving pipe 36 includes a flexible accordion segment 36A to allow for sufficient vertical movement. Alternatively, the receiving pipe 36 may comprise an elongate flexible tube that is looped to permit sufficient vertical movement of the pipe 36, thereby eliminating the need for the accordion segment 36A. The upper support member 45 is attached to an adjustment cord 47 connected to an adjustment lever 48 mounted on the support frame 13 outside of the container 12. As such, the adjustment lever controls the placement of the support members 40, 45 on the support rod 41, and the volume of water that enters the container 12. Preferably, the position of support members 40, 45 on support rod 41 can be varied such that a volume of four to fourteen gallons of water is received in the container 12.

As shown in FIG. 14, two exit spouts 49, 50 are positioned at the base of the container 12 and extend downward. The exit spouts 49, 50 terminate proximate the drum opening 14 when the drum 11 is in the dispensing position. The control lever 38 communicates with valves positioned within the spouts 49, 50 such that the valves are closed when the control lever 38 is positioned upward, and open when the control lever 38 is positioned downward. As such, water flows into the container 12 and is maintained in the container by the closed exit spouts 49, 50 when the control lever 38 is positioned upward. Moving the control lever 38 downward stops the flow of water into the container 12 by closing control valve 39 and opens the exit spouts 49, 50 to allow the water to flow out of the container 12 and into the cement mixer 19 positioned below the exit spouts 49, 50, as shown in FIG. 1.

As shown in FIGS. 1-4, the support frame 13 comprises an upper section 51 positioned on four lower legs 52A-D. The upper section 51 includes four hollow legs 51A-D, each having a hole formed therein. The legs 51A-D of the upper section 51 are slightly larger than the lower legs 52A-D. The legs 52A-D of the lower section include a series of linearly aligned holes 53 that are spaced apart approximately two inches from each other. The upper section legs 51A-D are telescoped over the lower section legs 52A-D such that the holes of the upper section legs 52A-D are aligned with holes 53 of the lower section legs 52A-D at a desired height. Pins 54 are positioned through the aligned holes to lock the upper section 51 and lower legs 52A-D in place at a desired height. The height of the support frame 13 can be adjusted by removing the pins 54 and aligning the holes of the upper section 51 with higher or lower holes 53 of the lower legs 52A-D.

A preferred embodiment of the dispenser 10 is comprised of stainless steel and has the following dimensions:
Drum 11 has a usable volume of six cubic feet.
Cylindrical sidewall 11A is 24 inches long and has a diameter of 24 inches.
Lateral end walls 11B, 11C have a diameter of 26 inches and is ¼ inch thick.
Drum opening 14 is 23 inches by 15 inches.
Hopper base opening 17 is 24 inches by 15 inches.

A preferred method for making cement using dispenser 10 includes the following steps. First, the support members 40, 45 are positioned on support rod 41 at a height such that the filler valve 42 will close when ten gallons of water is contained within the container 12. Next, the control lever 38 is turned upward, opening control valve 39 and closing exit spouts 49, 50, to allow water to start flowing into the container 12. Water continues to flow into the container 12 until there is ten gallons of water contained within container 12, at which point float 43 reaches upper support member 45 and filler valve 42 closes to stop further flow of water into the container 12. The control lever 38 is then moved downward to open exit spouts 49, 50. The water exits the container 12 and flows into the cement mixer 19 positioned directly below.

Next, one seventy-two pound bag of mortar mix is poured into the cement mixer 19. The drum 11 is positioned in the receiving position, as shown in FIG. 9. Sand flows from the hopper 15 through the drum opening 14 into the drum 11 until it is full. The wheel 23 is then rotated counterclockwise to move the drum 11 from the receiving position to the dispensing position as shown in FIGS. 11C and 11D. Once in the dispensing position, shown in FIG. 10, the six cubic feet of sand contained in the drum 11 empties out through drum opening 14 into the cement mixer 19 positioned below. Another seventy-two pound bag of mortar mix is poured into the cement mixer 19. Finally, the ten gallons of water, six cubic feet of sand and 144 pounds of mortar mix are thoroughly mixed together in the cement mixer 19 to form cement having a compression strength of approximately 1800 p.s.i. The drum 11 can be moved back to the receiving position by rotating the wheel 23 clockwise, as shown in FIGS. 11A and 11B. The invention substantially reduces the number of times the user must approach the mixer to add ingredients. Prior art methods typically required a worker to approach the mixer ten times to make one batch of cement, while the present invention requires only two approaches. By minimizing the number of approaches, the risk of sustaining an injury by contacting one of the blades of the mixer is reduced.

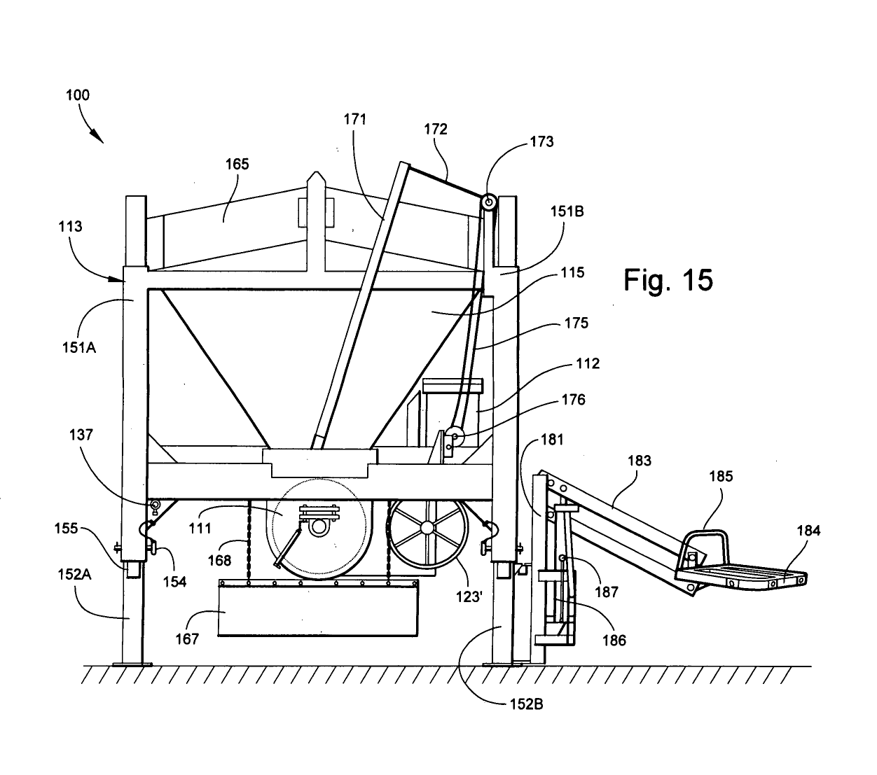

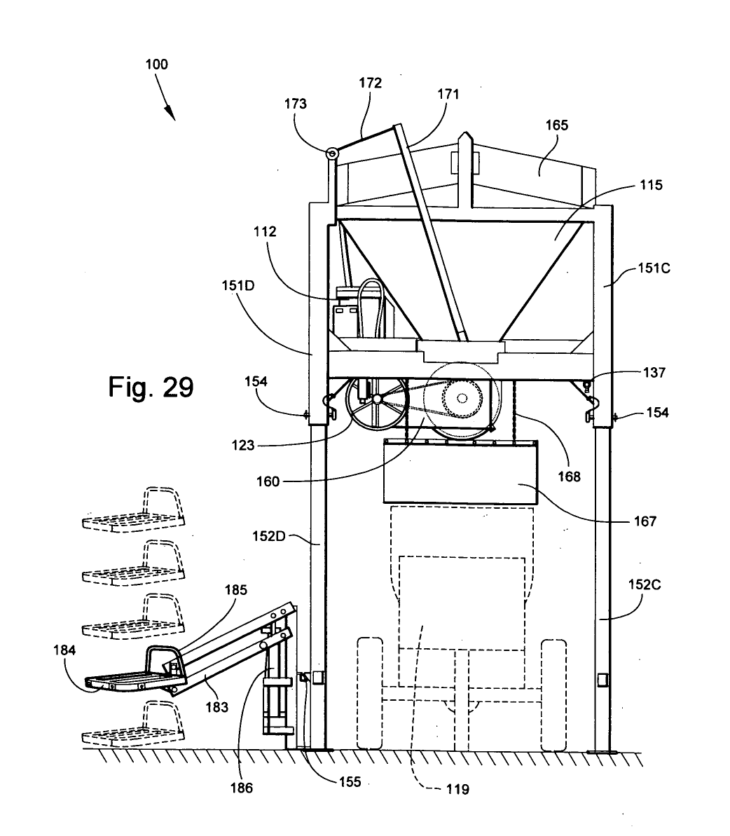

Another preferred embodiment of the volumetric solid and liquid dispenser according to the present invention is illustrated in FIGS. 15-35, and shown generally at reference numeral 100. The dispenser 100 includes a drum 111 and a liquid metering and dispensing assembly 112 mounted on a support frame 113. The drum 111 holds a predetermined volume of solid material, and the liquid dispensing assembly 112 stores and delivers a predetermined volume of a liquid. The dispenser 100 can be used to deliver measured volumes of any variety of solids and liquids. For example, the drum 111 and assembly 112 of the dispenser 100 can dispense sand and water, respectively, in an appropriate volumetric ratio for mixing with mortar to make cement.

As can be seen in FIGS. 15-18, the dispenser 100 includes a hopper 115 mounted on the support frame 113 above the drum 111. The hopper 115 preferably has four walls defining a relatively large top opening and converging into a relatively small base opening, as in the previously described embodiment 10. The base opening is positioned directly above the drum 111. The hopper 115 can be of any size, and is preferably sized to hold approximately 108 cubic feet of sand to supply the typical crew of eight masons for one full day of work.

The sand can be poured into the hopper 115 by a forklift or other suitable equipment. A guard panel 165 can be mounted on the support frame above the hopper 115 to prevent the forklift or other heavy equipment from scraping or otherwise damaging the hopper during pouring operations.

As shown in FIGS. 15-19, the dispenser 100 can include a cover assembly 170 that covers the solid material stored in the hopper 115. The cover assembly 170 includes a U-shaped arm 171 having two side members mounted on opposite sides of the support frame 113, and a cross member extending over the top of the hopper 115 and guard panel 165 and connecting the two side members. A cover 172 is attached at one end to the cross member of the arm 171. The other end of the cover 172 is wound on a roller 173 mounted on the support frame 113. The cover 172 can be any suitable material for covering the material in the hopper 115, such as a canvas or plastic tarp. The arm 171 is biased in the direction opposite to the roller 173. As such, tension is maintained in the cover 172, and the cover 172 is biased so as to cover the top of the hopper 115. The arm 171 can be biased in a variety of ways. For example, each of the side members of the arm 171 can be biased by a spring loaded coil 174, as shown in FIG. 20.

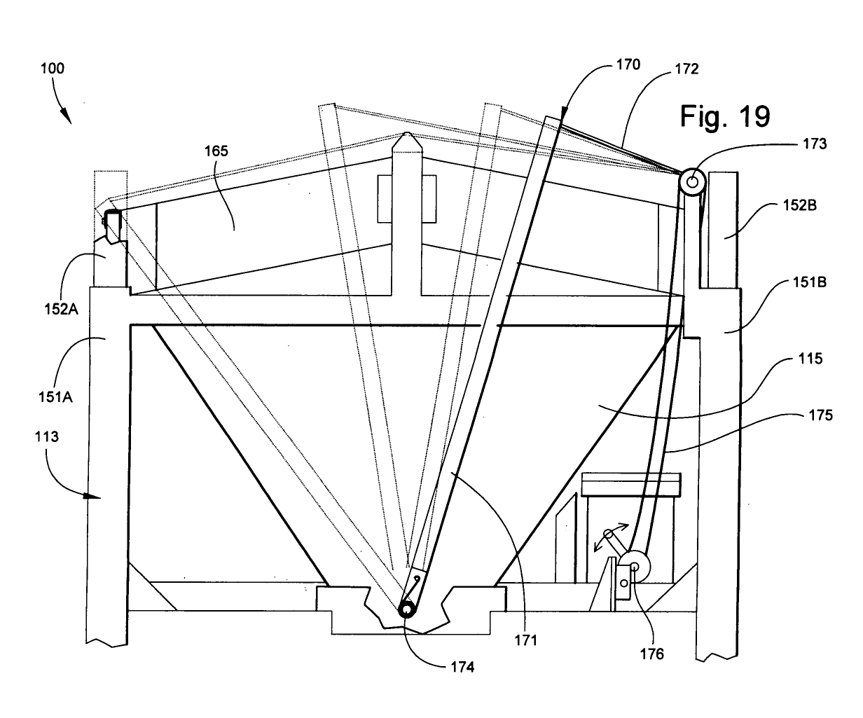

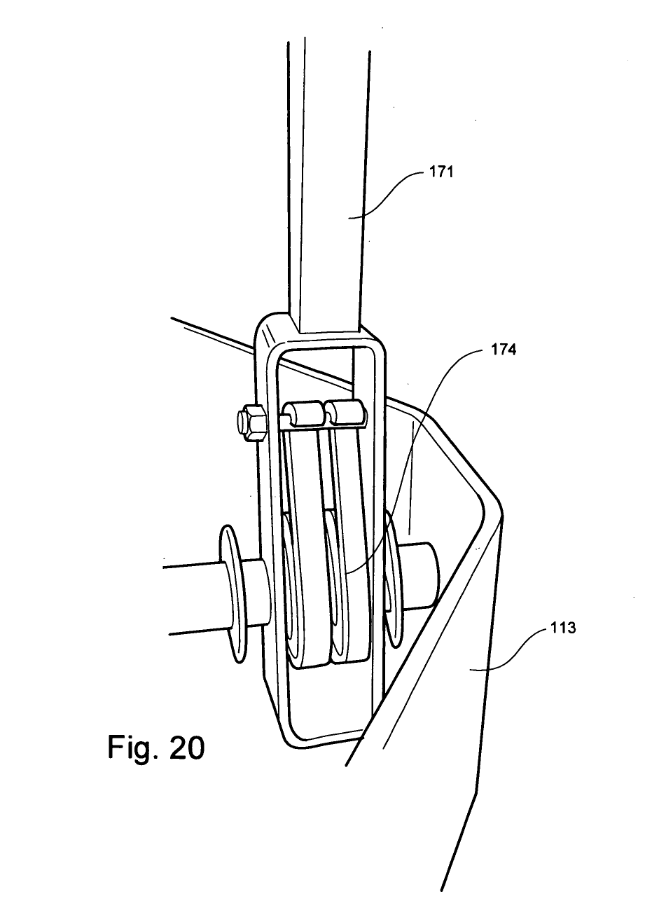

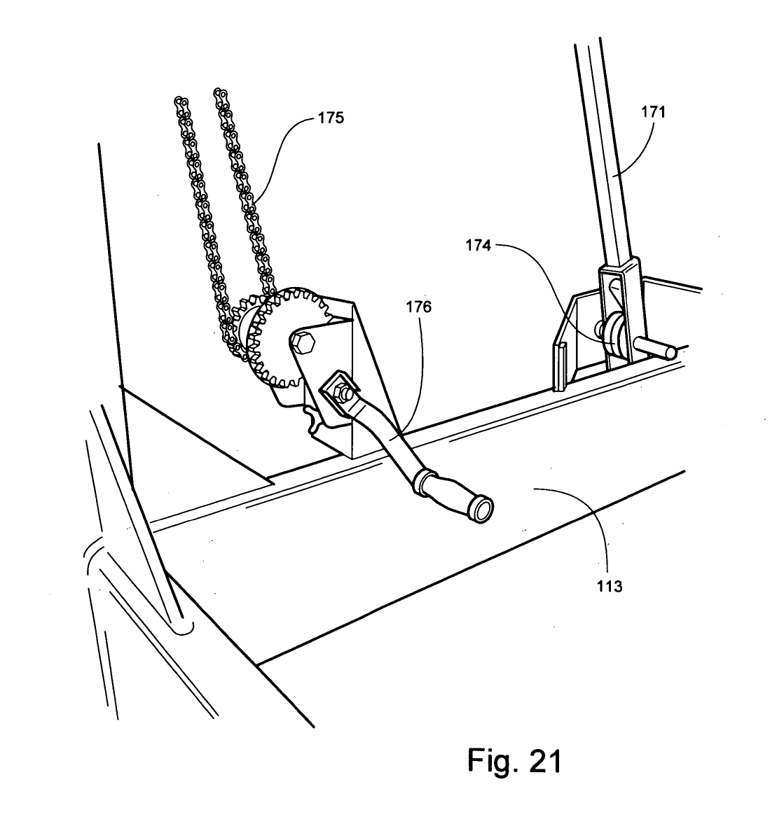

As shown in FIG. 19, the cover assembly 170 is moveable from a closed position, in which the cover 172 is fully extended over the top of the hopper 115, to an open position, in which the cover 172 does not extend over the top of the hopper 115. The cover assembly 170 includes a chain 175 that engages the roller 173 and extends downward to a crank 176 mounted on the support frame 113, as shown in FIG. 21. To move the closed position to the open position, the user turns the crank 176 in a clock-wise manner to pull the arm 171 toward the roller 173 and wind the cover 172 up on the roller 173. To return back to the open position, the user turns the crank counter -clockwise to unwind the cover 172 and allow the spring loaded coil 174 to urge the arm 171 away from the roller 173.

The drum 111 can be a variety of shapes, and preferably has a cylindrical sidewall and two opposed lateral end walls. The drum 111 can be of any volume, and is preferably sized to hold six cubic feet of sand. The drum 111 is identical in structure and operation as the drum 11 of the previously described embodiment 10, and therefore is not described in further detail.

A drive apparatus communicates with the drum 111 to rotate the drum 111 between a receiving position, in which the drum opening is upwardly directed and aligned with the hopper base opening, and a dispensing position, in which the drum opening is downwardly directed and aligned with a receptacle 119. The receptacle 119 can be any suitable container or equipment, such as a standard commercial cement mixer.

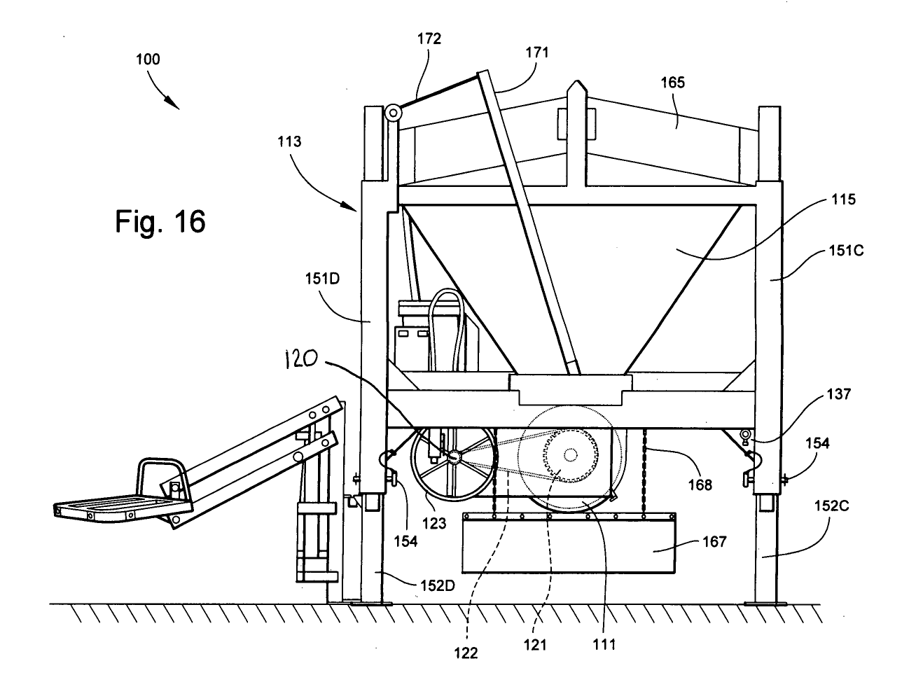

As shown in FIG. 16, the drive apparatus includes a drive sprocket 120 rotatably mounted on the support frame 113 and a relatively larger sprocket 121 mounted on one lateral end wall 111B of the drum 111. The sprockets 120,121 are connected by a chain 122 engaging the teeth of the sprockets 120,121 such that rotation of the drive sprocket 120 rotates sprocket 121 thereby rotating the drum 111. As shown in FIG. 16, the sproket 121 and chain 122 are positioned within a cover 160 that protects the sproket 121 and chain 122 from exposure to the outside elements and errant material.

An enlarged wheel 123 is mounted on the drive sprocket 120 to assist the user in manually rotating the drive sprocket 120. The wheel 123 can be of any suitable size and material the wheel 123 is preferably twenty inches in diameter and made of stainless steel. Alternatively, an electric motor can be used to rotate the drive sprocket 120.

As shown in FIG. 15, the dispenser 100 includes a second enlarged wheel 123′ positioned on the opposite side of the support frame 113. The second wheel 123′ is connected to the first wheel 123 by an axle 118, and enables the user to operate the dispenser 100 from the front or rear, depending on the current direction of the wind. The operation of drive apparatus of the dispenser 100 is identical to that of the previously described embodiment 10, and therefore is not described in further detail.

As shown in FIG. 15, a containment shield 127 is positioned adjacent the drum to prevent escape of solid material from the drum 111 due to centrifugal forces while the drum 111 is being rotated from the receiving position to the dispensing position. Preferably, the containment shield 127 is an arcuate plate sized to conform to the curvature of the cylindrical sidewall 11A. The containment shield 127 is pivotally mounted to the support frame, and extends approximately one hundred to one-hundred eighty degrees around the drum 111. The containment shield 127 is identical in structure to the containment shield 27 of the previously described embodiment 10, and therefore is not described in further detail. A splash guard 167 can be positioned between the drum 111 and the mixer 119 to minimize the user's exposure to the solid material being dispensed from the drum 111 to the mixer. The splash guard can be hung from an adjustable chain 168 mounted on the support frame 113 so that the position of the splash guard can be adjusted to accommodate mixers of varying height.

As shown in FIGS. 15-17, the dispenser 100 can include a lifter assembly 180 for lifting solid material to be placed in the receptacle 119. For example, the lifter assembly 180 can be used to lift bags of sand and position them proximate the top opening of a mixer to assist the user in pouring the sand into the mixer.

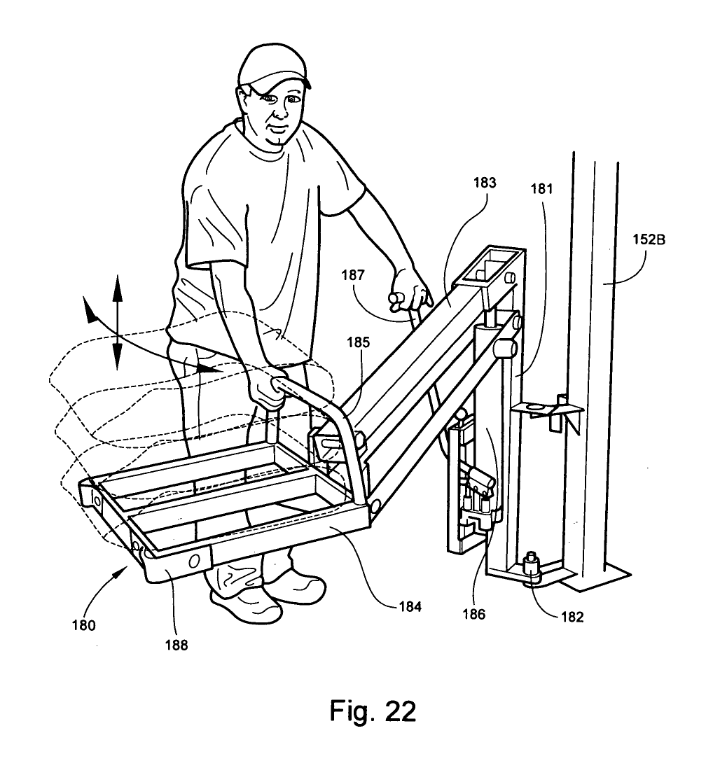

As shown in FIG. 22, the lifter assembly 180 includes a stanchion 181 that is connected by a pivot 182 to one of the legs 152B of the support frame 113. An arm 183 is pivotally connected at one end to the top of the stanchion 181. A platform 184 is connected at the opposite end of the arm 183. The platform 184 can include a handle bar 185 for the user to grip, as shown in FIG. 22. A hydraulic lift 186 is mounted on the stanchion 181 and is connected to the arm 183 such that engagement of the hydraulic lift urges the arm 183 upward. The hydraulic lift 186 can include a lever 187 for the user to engage the lift 185. It should be noted that other means for elevating the arm 183 could be employed, such as an electric lift. The platform 184 can be any suitable shape and size, and can be shaped and sized to accommodate several bags of sand, as shown in FIG. 22. A protective rubber piece 188 can be positioned on the edges of the platform 184 to prevent injury to the user.

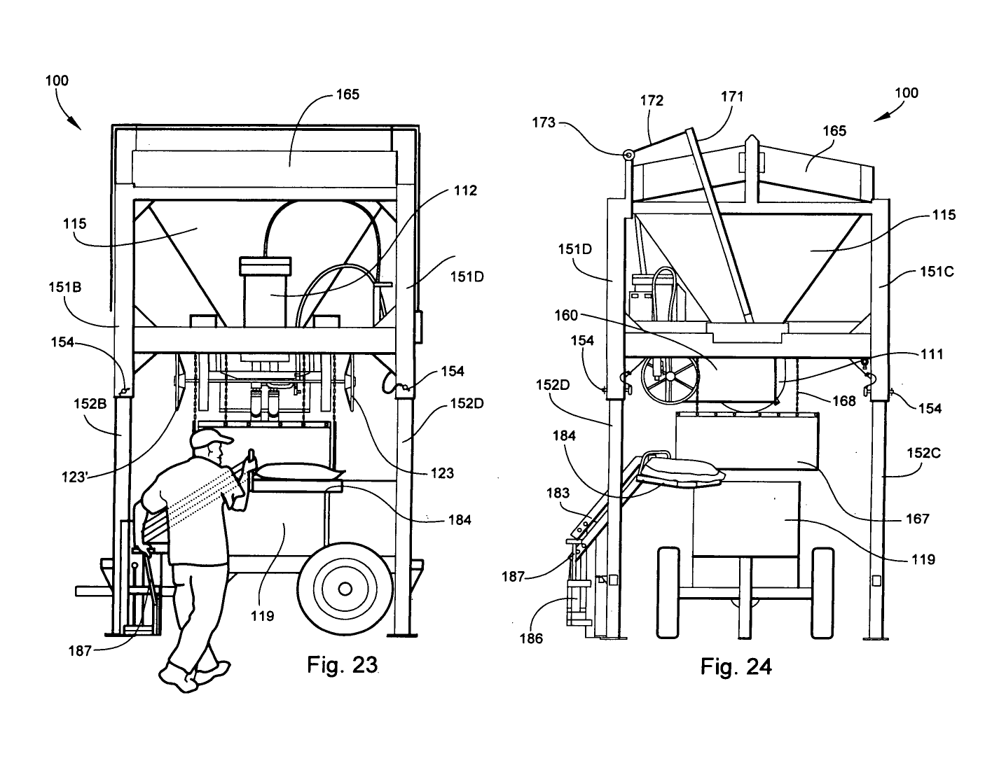

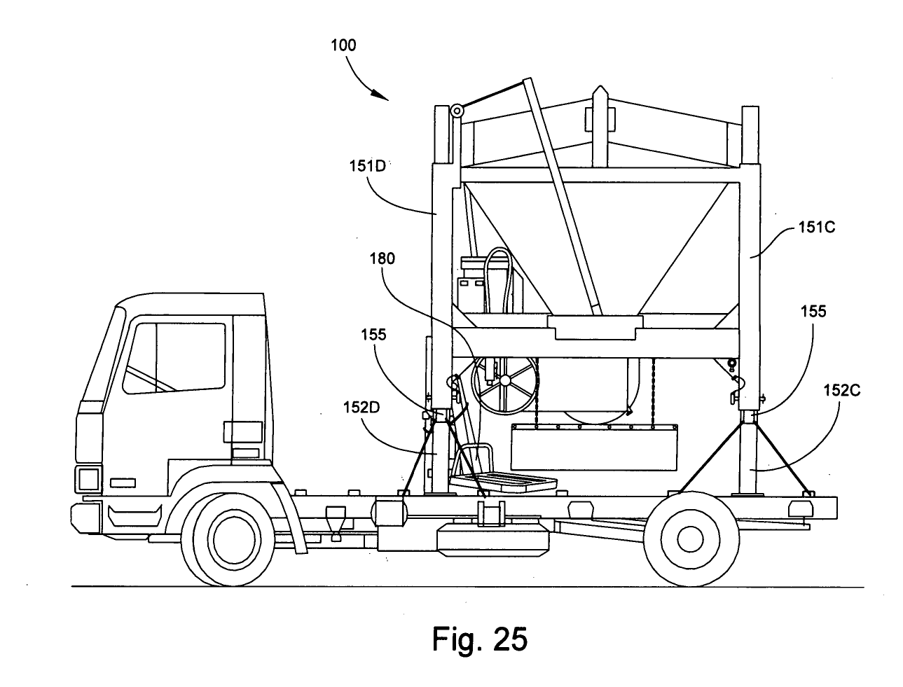

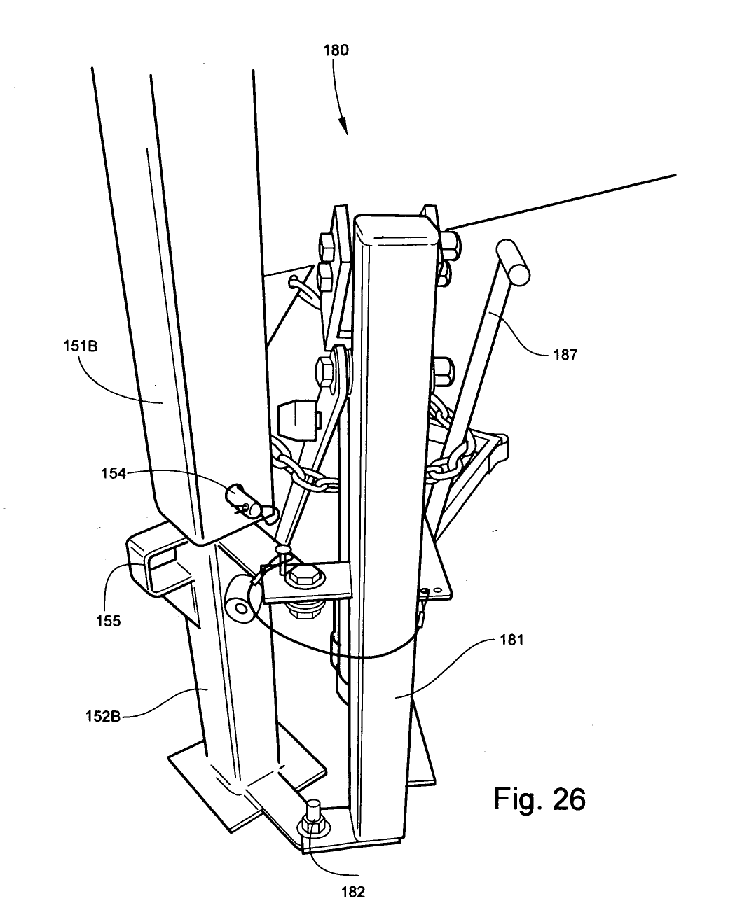

The lifter assembly 180 is moveable from a loading position, shown in FIG. 22, and an unloading position, shown in FIGS. 23 and 24. In the loading position, the platform 184 is pivoted away from the support frame 113, and is lowered proximate the ground surface to facilitate the placement of bags of sand on the platform 184. Once the platform 184 is loaded with the desired bags of sand, the user can grip the handle bar 185 and pivot the platform 184 around to the mixer 119, as shown in FIGS. 23 and 24. The user then raises the platform 184 by engaging the lever 186 on the hydraulic lift 185. The platform 184 is raised so that it resides approximately on the same horizontal plane as the top opening of the mixer 119 in order to facilitate the pouring of the sand into the mixer 119. During transport of the dispenser 100, the platform 184 is lowered and the lifter assembly 180 is positioned under the drum 111, as shown in FIGS. 25 and 26.

The liquid dispensing assembly 112 receives and dispenses a desired volume of liquid into the mixer 119, as shown in FIG. 26. The liquid dispensing assembly 112 includes a container 102 that can be sized to hold any desired volume of liquid. The container 102 preferably holds up to approximately fifteen gallons of liquid water. Preferably, the assembly 112 receives and dispenses approximately ten gallons of water into the cement mixer 119 for mixing with six cubic feet of sand and 144 pounds of mortar mix.

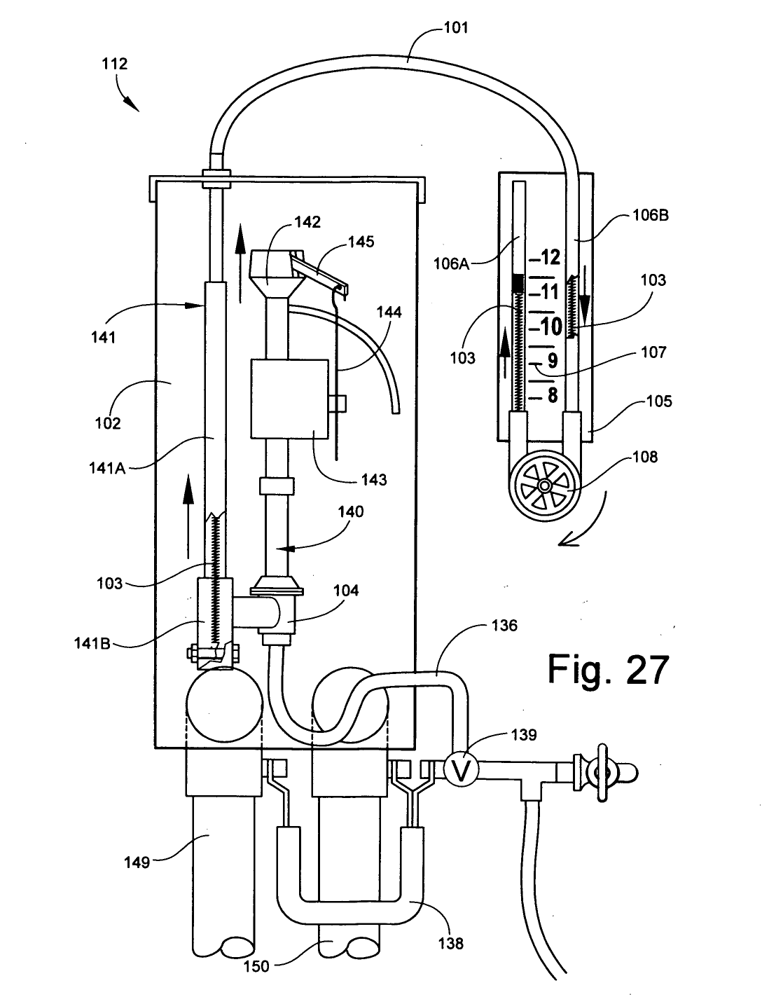

As shown in FIG. 27, liquid is introduced into the container 102 through a receiving tube 136. A control lever 138 communicates with a control valve 139 that is positioned within the receiving pipe 136 prior to entering the container 102 to control the flow of water into the container 102. When the control lever 138 is positioned downward, the control valve 139 is closed and no water can enter the container 102. Moving the control lever 138 upward opens the control valve 139 to allow water to continue to flow through the receiving pipe 136 and ultimately enter the container 102.

As shown in FIG. 27, a float assembly 140 is positioned inside of the container 102 and operates similarly to a toilet. The receiving pipe 136 enters the container 102 and terminates at a lower support member 104 positioned proximate the base of the container 102 and connected to a support rod 141. A filler valve 142 is mounted on the support member 104. A filler float 143 communicates with the filler valve 142 via a connecting wire 144 and hinged arm 145 to cut off the flow of water into the container 102 once a certain volume of liquid has been attained. As liquid fills up the container 102, the float 143 rises with the liquid. When the float 143 rises high enough to fully elevate the hinged arm 145, the filler valve 142 closes to stop further flow of liquid into the container 102. As such, the volume of liquid entering the container 102 can be controlled by positioning of the float assembly 140 at a certain height in the container 102.

The support rod 141 is connected to a tube 101 that extends through the top of the container 102. The support rod 141 preferably includes two telescoped members 141a, 141b to allow for vertical movement of the support rod 141. The tube 101 extends into a gear box 105. A cable 103 is positioned within the tube 101, and is engaged by the gear box 105. The cable extends into the support rod 141, and is connected to the base of the support rod 141. As such, movement of the cable 103 moves the support rod 141, which moves the float assembly 140 vertically in the container 102. An adjustment wheel 108 is mounted on the gear box 105. Clockwise rotation of the wheel 108 pulls the cable 103 away from the container 102, thereby moving the support rod 141 and float assembly 140 upward, and increasing the volume of liquid that is to be received in the container 102. Counter-clockwise rotation of the gear box wheel 108 forces the cable toward the container 102, thereby moving the support rod 141 and float assembly 140 downward, and decreasing the volume of liquid to be received in the container 102.

The gear box 105 includes substantially parallel channels 106a, 106b for positioning the tube 101. The cable 103 terminates in one of the channels, preferably the left channel 106a. The gear box 105 includes markings 107 along the left channel 106a that indicate a range of volumes that can be received by the container 102. The tube 101 and the channel 106a are clear so that the cable 103 within the tube 101 is visible to the user. The indicator markings 107 are placed on the gear box 105 to correspond to the position of the cable that is necessary to move the float assembly 140 into a position that will yield the volume of liquid indicated on the particular marking 107. As such, a user can set the liquid dispensing assembly 112 to receive and dispense a particular volume of liquid, by turning the wheel 108 of the gear box 105 to position the end of the cable 103 in channel 106a at the indicator marking 107 of the desired volume. Such movement of the cable 103 results in the floating assembly 140 being moved into a position that will provide the desired volume of liquid in container 102. For example, in FIG. 27, the cable 103 is positioned such that the liquid dispensing assembly 112 will receive and deliver 11.5 gallons of liquid.

The receiving tube 136 can include a flexible accordion segment to allow for sufficient vertical movement. Alternatively, the receiving tube 136 may comprise an elongate flexible tube that is looped to permit sufficient vertical movement of the tube 136.

As shown in FIG. 27, two exit spouts 149, 150 are positioned at the base of the container 102 and extend downward. The exit spouts 149, 150 terminate proximate the drum opening when the drum 111 is in the dispensing position. The control lever 138 communicates with valves positioned within the spouts 149, 150 such that the valves are closed when the control lever 138 is positioned upward, and open when the control lever 138 is positioned downward. As such, liquid flows into the container 102 and is maintained in the container by the closed exit spouts 149, 150 when the control lever 138 is positioned upward. Moving the control lever 138 downward stops the flow of liquid into the container 102 by closing control valve 139 and opens the exit spouts 149, 150 to allow the water to flow out of the container 12 and into the cement mixer 119 positioned below the exit spouts 149, 150.

As shown in FIG. 15, a faucet 137 can be mounted on the support frame 113. The faucet 137 provides a water source for cleaning the dispenser 100, mixer 119 and other equipment used at the job site.

As shown in FIGS. 15-18 and 28-30, the support frame 113 includes an outer section 151 positioned on four inner legs 152A-D. The outer section 151 includes four hollow legs 151A-D, telescopically positioned over the four inner legs 152A-D. Each of the inner section legs 152A-D include upper and lower aligned spaced apart holes. Each of the outer section legs 151A-D have at least one hole that is positioned for aligning with the upper and lower holes of the inner section legs 152A-D. Leg pins 154 can be positioned through the aligned holes to lock the outer section legs 151A-D and inner section legs 152A-D in place at the desired height.

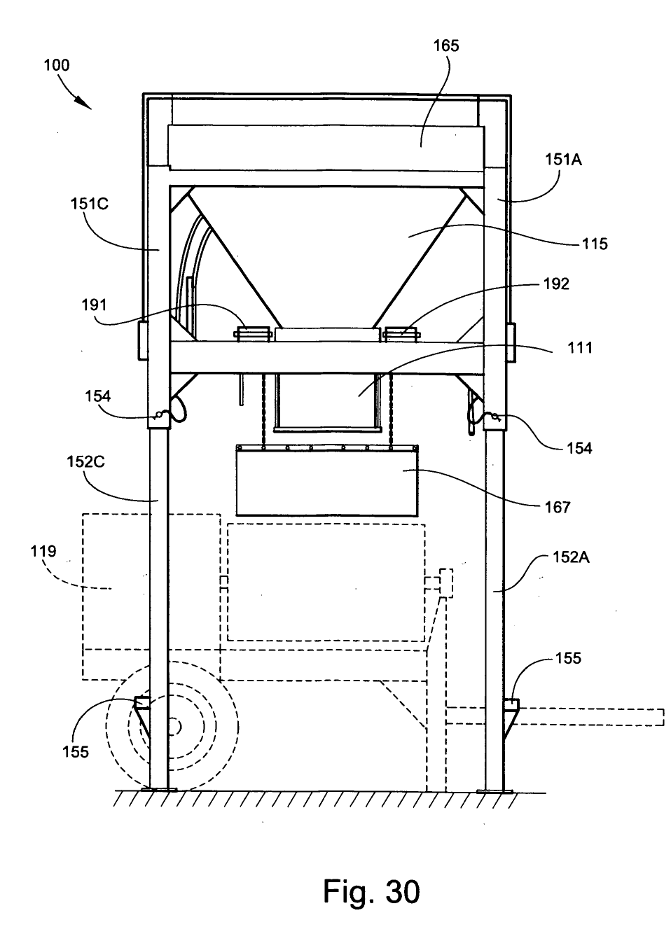

As shown in FIGS. 30-34, two fork lift channels 191, 192 can be mounted on the outer section 151 of the support frame 113. The fork lift channels 191, 192 are sized to receive forks “F” from a fork lift. Each of the channels 191, 192 include two apertures for inserting fork lock pins 193, 194, respectively.

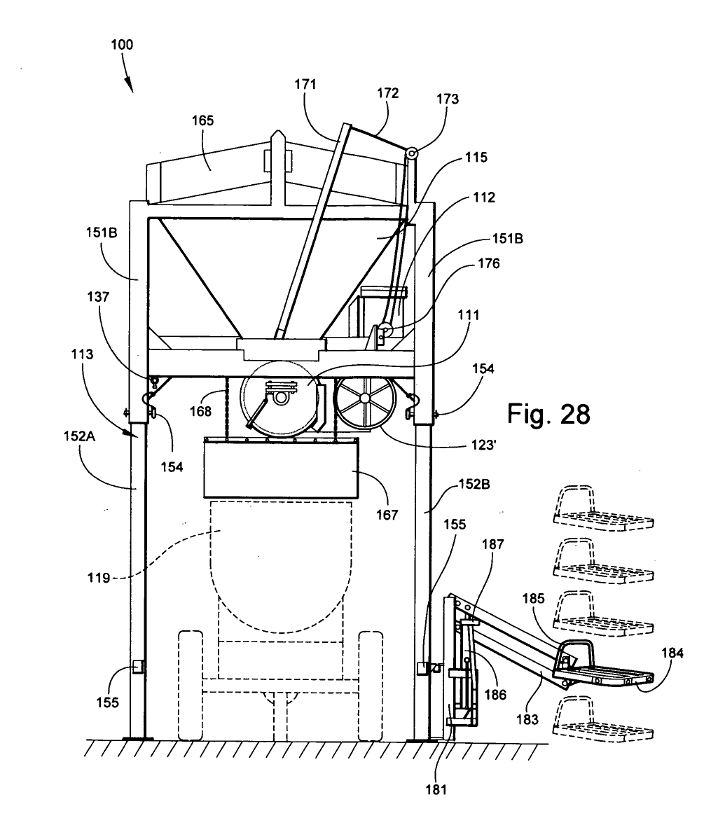

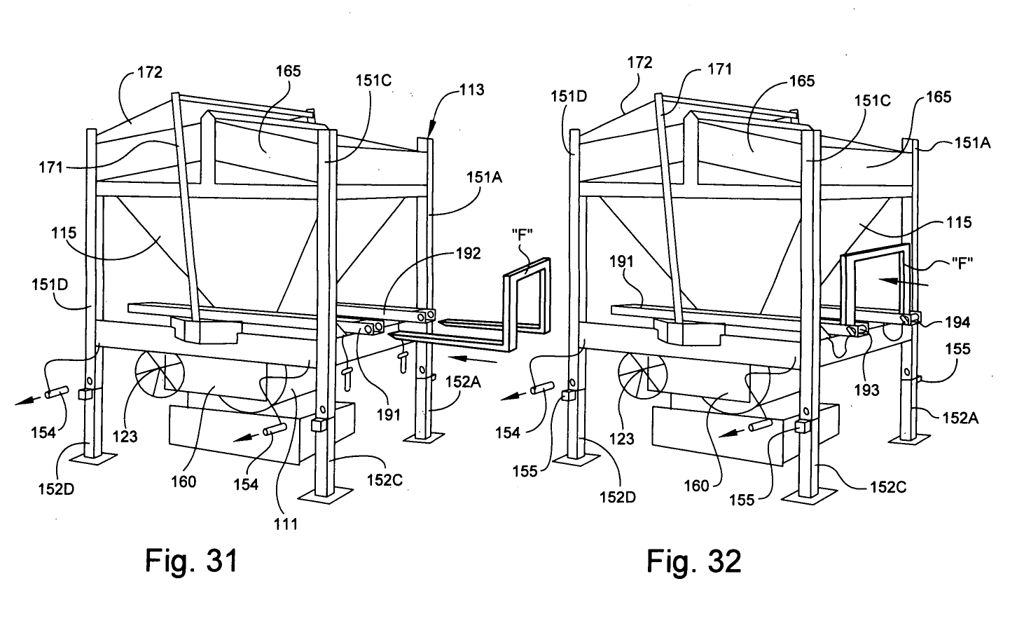

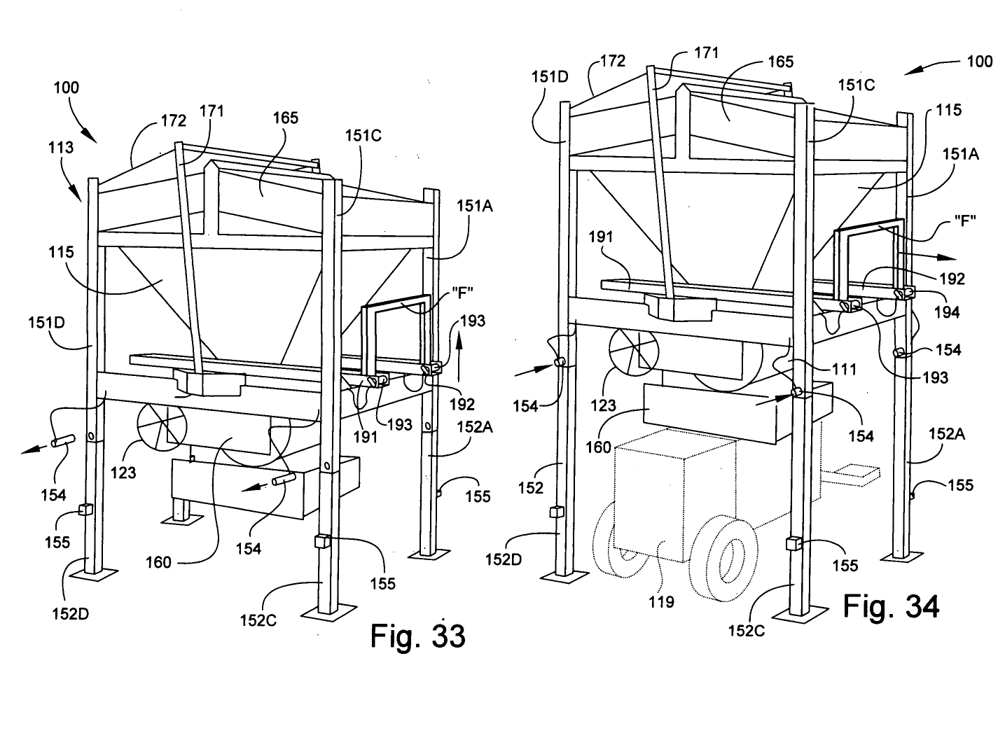

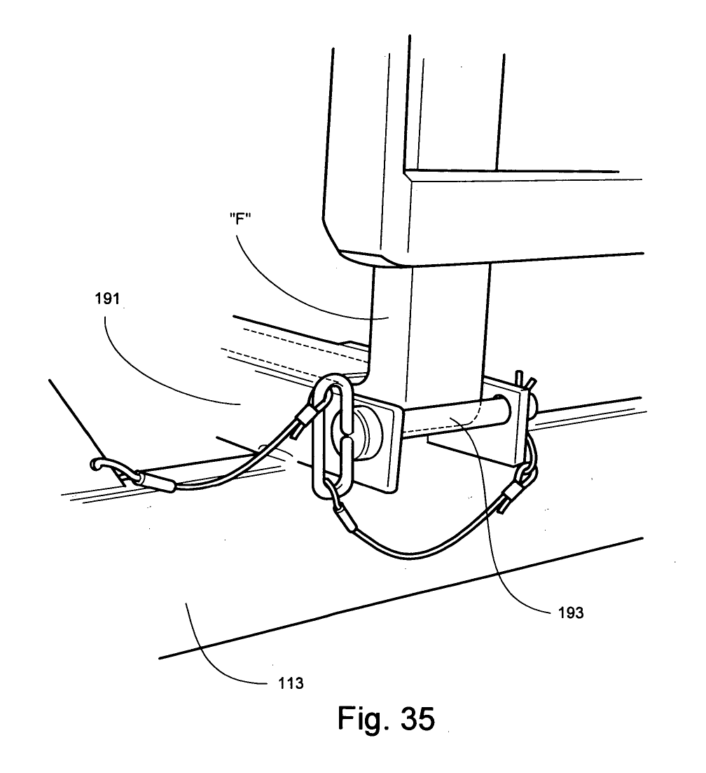

The dispenser 100 is moveable from a lower position, shown in FIGS. 15-18, used for storage and transport of the dispenser 100, to a raised position, shown in FIGS. 28-30, which provides enough clearance to position the mixer 119 below the drum 111 for dispensing operations. To lift the dispenser 100 from the lower position to the raised position, the pins 154 are removed from the outer section legs 151A-D and inner section legs 152A-D of the support frame 113, and the forks of a fork lift are inserted into the fork lift channels 191, 192, as shown in FIGS. 31 and 32. The fork lock pins 193, 194 are inserted into the apertures of the fork lift channels 191, 192 to securely keep the forks “F” in the channels 191, 192, as shown in FIG. 35. Cotter keys are inserted into the fork lock pins 193,194. The fork lift raises the upper section 151 of the support frame 113 to a point where the holes of the upper section legs 151A-D are aligned with the upper holes of the inner section legs 152A-D, and the leg pins 154 are inserted through the aligned holes to log the dispenser 100 in place at the desired height, as shown in FIGS. 33 and 34. The mixer 119 can now be positioned under the drum 111.

The dispenser 100 should be positioned in the lower position, shown in FIGS. 15-18, during transport. The dispenser 100 can be raised off the ground by a fork lift and set on the transport bed of a suitable vehicle.

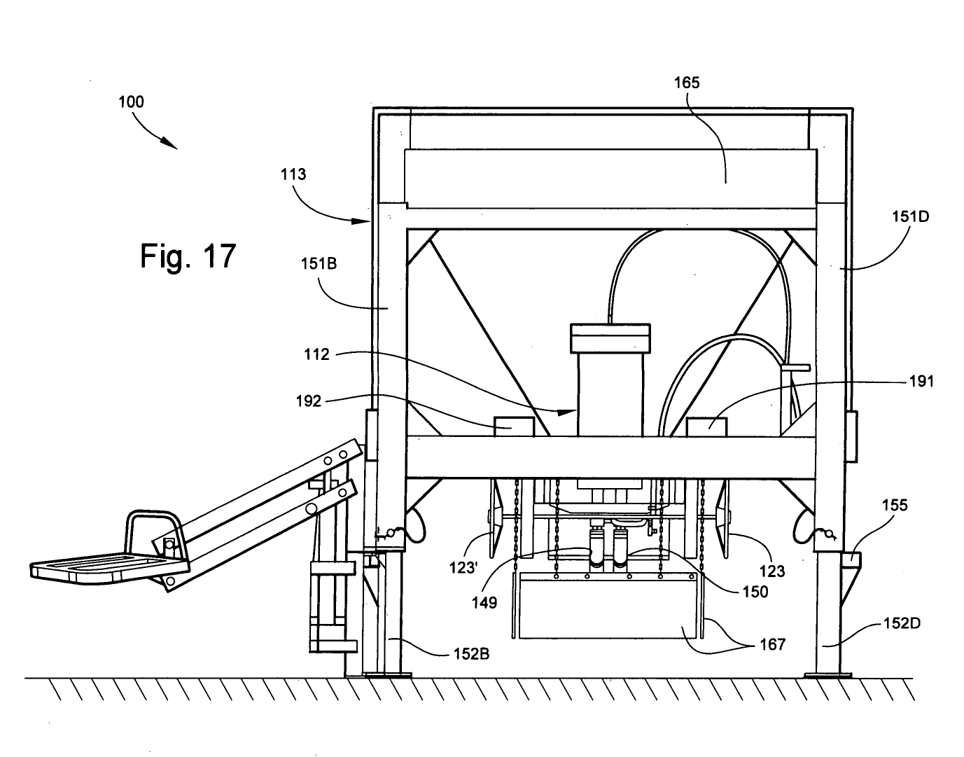

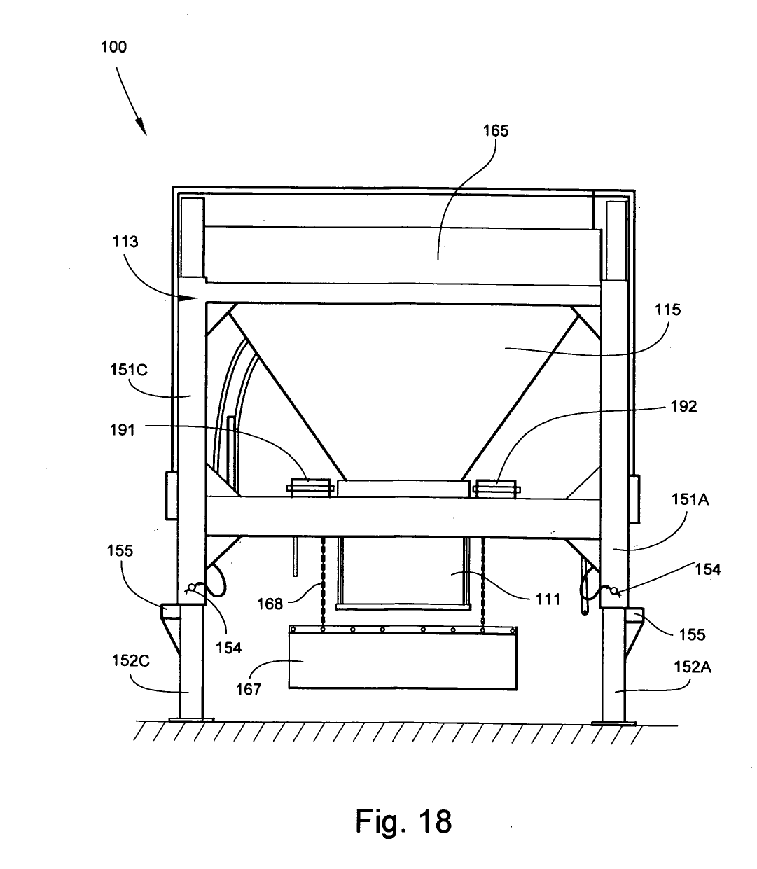

As shown in FIGS. 17 and 18, each of the inner section legs 152A-D has a stop piece 155 positioned below the lower hole. The stop piece 155 is a safety feature that prevents the upper section 151 from falling all the way to the ground in the event the leg pins 154 break or fall out of their holes. In addition, the stop piece 155 is hollow to allow for a chain to be looped through to secure the dispenser 100 during transport. Furthermore, the stop piece 155 can act as a step for the user to access the upper regions of the dispenser 100.

A volumetric solid and liquid dispenser and method of using same is disclosed above. Various embodiments of the invention can be made without departing from its scope. Furthermore, the foregoing description of the preferred embodiments of the invention and the best mode for practicing the invention are provided for the purpose of illustration only and not for the purpose of limitation—the invention being defined by the claims.

1. An apparatus for dispensing a solid material and a liquid material into a receptacle, comprising:
(a) a drum having an opening therein and sized for receiving and containing a predetermined volume of solid material;
(b) a hopper positioned above the drum for allowing free flow of the solid material into the drum;
(c) a discharge assembly for discharging the predetermined volume of solid material from the drum into the receptacle;
(d) a liquid dispensing assembly for receiving and dispensing a predetermined volume of liquid material into the receptacle for mixing with the solid material; and
(e) a support frame for mounting the drum, the hopper and the liquid dispensing assembly in an elevated position above the receptacle.

2. A dispensing apparatus according to claim 1, further comprising a lifter assembly for lifting material to be placed into the receptacle, wherein the lifter assembly is moveable from a loading position for loading the material on the lifter assembly to an unloading position proximate to the receptacle for placing the material into the receptacle.

3. A dispensing apparatus according to claim 2, wherein the lifter assembly is pivotally connected to the support frame.

4. A dispensing apparatus according to claim 2, wherein the receptacle comprises a cement mixer.

5. A dispensing apparatus according to claim 2, wherein the lifter assembly includes a platform for carrying the material to be placed in the receptacle.

6. A dispensing apparatus according to claim 5, wherein the lifter assembly includes means for elevating the platform, whereby the platform can be elevated from the loading position wherein the platform is proximate a ground surface, and the unloading position wherein the platform is proximate an upper opening of the receptacle.

7. A dispensing apparatus according to claim 5, wherein the lifter assembly includes a hydraulic lift for elevating the platform, whereby the platform is moveable from the loading position wherein the platform is proximate a ground surface, and the unloading position wherein the platform is proximate an upper opening of the receptacle.

8. A dispensing apparatus according to claim 7, wherein the lifter assembly includes an arm having a first end carried by the hydraulic lift and a second end for carrying the platform.

9. A dispensing apparatus according to claim 1, wherein the discharge assembly comprises a drive apparatus for moving the drum from a receiving position wherein the opening in the drum is positioned to receive the solid material, and a dispensing position wherein the opening in the drum is inverted to dispense the solid material to the receptacle positioned below the drum.

10. A dispensing apparatus according to claim 9, further comprising a splash guard positioned below the drum and defining a pathway for solid material flowing from the drum to the receptacle, wherein the splash guard is connected to at least one adjustable member mounted on the support frame whereby the position of the splash guard can be adjusted in relation to the height of the receptacle.

11. A dispensing apparatus according to claim 10, wherein the drum comprises a cylindrical side wall and two opposed lateral end walls, the drum opening formed in the cylindrical sidewall, and further comprising a containment shield positioned adjacent to the cylindrical side wall of the drum and adapted to conform to the cylindrical sidewall and cover the drum opening as the drum is rotated between the receiving and dispensing positions whereby the containment shield prevents escape of the solid material through the drum opening while positioned between the receiving and dispensing positions.

12. A dispensing apparatus according to claim 1, wherein the hopper includes a top opening for receiving the solid material and a base opening for dispensing the solid material, and further comprising a cover assembly for covering the top opening of the hopper.

13. A dispensing apparatus according to claim 12, wherein the cover assembly includes:
(a) an arm mounted on the support frame; and
(b) a cover having a first end carried by the arm and a second end wound on a roller mounted on the support frame, wherein the arm is biased away from the roller to maintain tension in the cover whereby rotation of the roller alters an extent of coverage of the top opening of the hopper by the cover.

14. A dispensing apparatus according to claim 13, wherein the cover can be opened and closed by selectively rotating the roller in clockwise and counterclockwise directions.

15. A dispensing apparatus according to claim 13, wherein the cover assembly further comprises a chain engaging the roller and a crank mounted on the support frame, whereby the roller can be rotated by turning the crank.

16. A dispensing apparatus according to claim 1, further comprising a guard panel mounted on the support frame and positioned above the hopper for protecting the hopper during loading of the solid material into the hopper.

17. A dispensing apparatus according to claim 1, further comprising at least one fork lift channel mounted on the support frame for receiving a fork from a fork lift whereby the dispensing apparatus can be moved by a fork lift.

18. A dispensing apparatus according to claim 17, wherein the at least one fork lift channel defines at least one aperture, and further comprising a lock pin for inserting in the aperture to maintain the fork within the fork channel.

19. A dispensing apparatus according to claim 1, wherein the liquid dispensing assembly comprises:
(a) a container mounted on the support frame and having an entry opening in communication with a source for the liquid material and an exit opening for exiting the predetermined volume of liquid material;
(b) a float assembly positioned within the container and including a float suspendable on the liquid material and operatively associated with a first valve proximate the entry opening, wherein raising the float to a predetermined level within the container closes the first valve over the entry opening to prevent entry of additional liquid material into the container;
(c) a moveable support member positioned within the container and carrying the float assembly; and
(d) a cable in communication with the support member and operatively associated with an adjustment piece positioned outside of the container whereby the height of the float assembly can be adjusted by engaging the adjustment piece.

20. A dispensing apparatus according to claim 19, wherein the adjustment piece comprises a gear box.

21. A dispensing apparatus according to claim 19, wherein the liquid dispensing assembly further comprises:
(a) a second valve proximate the exit opening; and
(b) a lever operatively associated with the second valve whereby the lever is moveable from a dispensing position wherein the second valve is open to a filling position wherein the second valve is closed.

22. A dispensing apparatus according to claim 20, wherein the lever is operatively associated with the first valve whereby the lever is moveable from the dispensing position wherein the first valve is-closed and the second valve is open to the filling position wherein the first valve is open and the second valve is closed.

23. A dispensing apparatus according to claim 19, further comprising an indicator having markings showing at least two predetermined volumes that can be dispensed by the liquid dispensing assembly, and further wherein the cable includes a first end positioned within the indicator and a second end connected to the support frame and the position of the first end of the cable relative to the markings of the indicator corresponds to the volume of the liquid material to be dispensed from the liquid dispensing assembly whereby a desired volume of liquid material can be obtained by moving the cable with the adjustment piece so that the first end of the cable is positioned at the marking corresponding to the desired volume.

24. A dispensing apparatus according to claim 23, wherein the support member comprises at least two telescoped rods, and the cable is positioned within a tube extending from the indicator to the support frame.

25. A dispensing apparatus according to claim 24, wherein a portion of the tube proximate the markings on the indicator is clear whereby the cable is visible therethrough.

26. An apparatus for dispensing a predetermined volume of a liquid comprising:
(a) a container having an entry opening in communication with a source for the liquid and an exit opening for exiting the predetermined volume of liquid;
(b) a float assembly positioned within the container and including a float suspendable on the liquid and operatively associated with a first valve proximate the entry opening, wherein raising the float to a predetermined level within the container closes the first valve over the entry opening to prevent entry of additional liquid material into the container;
(c) a moveable support member positioned within the container and carrying the float assembly; and
(d) a cable in communication with the support member and operatively associated with an adjustment piece positioned outside of the container whereby the height of the float assembly can be adjusted by engaging the adjustment piece.

27. A liquid dispensing apparatus according to claim 26, wherein the adjustment piece comprises a gear box.

28. A liquid dispensing apparatus according to claim 26, further comprising an indicator having markings showing at least two predetermined volumes that can be dispensed by the apparatus, and further wherein the cable includes a first end positioned within the indicator and a second end connected to the support frame, the position of the first end of the cable relative to the markings of the indicator corresponding to the volume of the liquid to be dispensed whereby a desired volume of liquid material can be obtained by moving the cable with the adjustment piece so that the first end of the cable is positioned at the marking corresponding to the desired volume.

29. A dispensing apparatus according to claim 28, wherein the support member comprises at least two telescoped rods, and the cable is positioned within a tube extending from the indicator to the support frame.

30. A dispensing apparatus according to claim 29, wherein a portion of the tube proximate the markings on the indicator is clear whereby the cable is visible therethrough.
